(19) United States
(12) Patent Application Publication
(10) Pub. No.: US 2025/0285368 A1
(43) Pub. Date: Sep. 11, 2025

(54) INFORMATION PROCESSING APPARATUS, INFORMATION PROCESSING METHOD, AND RECORDING MEDIUM

(71) Applicant: NEC Corporation, Tokyo (JP)

(72) Inventors: Masahiro YAMAGUCHI, Tokyo (JP); Kyota Higa, Tokyo (JP); Yang Yang, Tokyo (JP)

(73) Assignee: NEC Corporation, Tokyo (JP)

(21) Appl. No.: 19/010,283

(22) Filed: Jan. 6, 2025

(30) Foreign Application Priority Data
Mar. 8, 2024 (JP) 2024-036149

(51) Int. Cl. G06T 15/40; G06T 7/50; G06T 17/00

(52) U.S. Cl. CPC G06T 15/40; G06T 7/50; G06T 17/00; G06T 2207/10028; G06T 2207/20081; G06T 2207/20084; G06T 2210/56

(57) ABSTRACT

An information processing apparatus includes at least one processor, the at least one processor executing: an obtaining process of obtaining input data; a three-dimensional structure data generating process of generating three-dimensional structure data from the input data; a sampling process of generating sampled three-dimensional structure data by sampling the three-dimensional structure data; a completing process with respect to the sampled three-dimensional structure data with use of a completion model; an estimating process of executing a shape estimating process in which an intermediate feature value in the completing process is referred to; and a first training process of training the completion model with reference to a first loss value which is a loss value pertaining to a shape that has been obtained by the shape estimating process.

This application is based upon and claims the benefit of priority from Japanese patent application No. 2024-036149, filed on Mar. 8, 2024, the disclosure of which is incorporated herein in its entirety by reference.

### TECHNICAL FIELD

The present invention relates to an information processing apparatus, an information processing method, and a recording medium.

### BACKGROUND ART

There is known a technique of scanning the real world with use of a sensor and reconstructing the real world. In three-dimensional data obtained by this reconstruction, an occluded region or a missing region can appear. Thus, there is also known a method of completing these regions (for example, Non-Patent Literature 1).

### CITATION LIST

### Non-Patent Literature

### [Non-patent Literature 1]

Angela Dai et. al., SG-NN: Sparse Generative Neural Networks for Self-Supervised Scene Completion of RGB-D Scans, 2020 IEEE/CVF Conference on Computer Vision and Pattern Recognition (CVPR).

### SUMMARY OF INVENTION

### Technical Problem

The technique disclosed in Non-Patent Literature 1 is a Voxel-based three-dimensional shape completing method. The technique has a problem that the ability of expressing a space is limitative.

The present disclosure has been made in view of the above problem, and an example object thereof is to provide a three-dimensional shape completing method in which the ability of expressing a space is improved.

### Solution to Problem

An information processing apparatus in accordance with an example aspect of the present disclosure includes at least one processor and a memory which is configured to store instructions, the at least one processor executing: an obtaining process of obtaining input data; a three-dimensional structure data generating process of generating three-dimensional structure data from the input data; a sampling process of generating sampled three-dimensional structure data by sampling the three-dimensional structure data; a completing process with respect to the sampled three-dimensional structure data with use of a completion model; a shape estimating process in which an intermediate feature value in the completing process is referred to; and a first training process of training the completion model with reference to a first loss value which is a loss value pertaining to a shape that has been obtained by the shape estimating process.

An information processing apparatus in accordance with an example aspect of the present disclosure includes at least one processor and a memory which is configured to store instructions, the at least one processor executing: an obtaining process of obtaining input data; a three-dimensional structure data generating process of generating three-dimensional structure data from the input data; a completing process with respect to the three-dimensional structure data with use of a completion model; and an output data generating process of generating output data from the three-dimensional structure data to which the completing process has been applied, the completion model being a model which has been trained by: a sampling process of generating sampled three-dimensional structure data by sampling three-dimensional structure data generated from training data; a completing process with respect to the sampled three-dimensional structure data with use of the completion model; a shape estimating process in which an intermediate feature value in the completing process is referred to; and a first training process of training the completion model with reference to a first loss value which is a loss value pertaining to a shape that has been obtained by the shape estimating process.

An information processing method in accordance with an example aspect of the present disclosure includes: obtaining input data; generating three-dimensional structure data from the input data; generating sampled three-dimensional structure data by sampling the three-dimensional structure data; applying, to the sampled three-dimensional structure data, a completing process with use of a completion model; executing a shape estimating process in which an intermediate feature value in the completing process is referred to; and training the completion model with reference to a first loss value which is a loss value pertaining to a shape that has been obtained by the shape estimating process.

### Advantageous Effects of Invention

An example aspect of the present disclosure brings about an example effect that it is possible to provide a three-dimensional shape completing method in which the ability of expressing a space is improved.

### BRIEF DESCRIPTION OF DRAWINGS

FIG. 1 is a block diagram illustrating a configuration of an information processing apparatus in accordance with the present disclosure.

FIG. 2 is a flowchart illustrating a flow of an information processing method in accordance with the present disclosure.

FIG. 3 is a block diagram illustrating a configuration of an information processing apparatus in accordance with the present disclosure.

FIG. 4 is a flowchart illustrating a flow of an information processing method in accordance with the present disclosure.

FIG. 5 is a block diagram illustrating a configuration of an information processing apparatus in accordance with the present disclosure.

FIG. 6 is a diagram illustrating a process carried out in the information processing apparatus in accordance with the present disclosure.

FIG. 7 is a diagram illustrating a flow of data in the information processing apparatus in accordance with the present disclosure.

FIG. 8 is a diagram illustrating a flow of a process carried out in the information processing apparatus in accordance with the present disclosure.

FIG. 9 is a diagram illustrating a flow of a process carried out in the information processing apparatus in accordance with the present disclosure.

FIG. 10 is a block diagram illustrating a configuration of an information processing apparatus in accordance with the present disclosure.

FIG. 11 is a diagram illustrating a flow of a process carried out in the information processing apparatus in accordance with the present disclosure.

FIG. 12 is a block diagram illustrating a configuration of an information processing apparatus in accordance with the present disclosure.

FIG. 13 is a block diagram illustrating a hardware configuration of an information processing apparatus in accordance with the present disclosure.

### EXAMPLE EMBODIMENTS

The following will exemplify embodiments of the present invention. Note, however, that the present invention is not limited to the example embodiments described below, but may be altered in various ways by a skilled person within the scope of the claims. For example, the present invention can also encompass, in its scope, any example embodiment derived by appropriately combining technical means employed in the example embodiments described below. Further, the present invention can also encompass, in its scope, any example embodiment derived by appropriately omitting a part of a technical means employed in each of the example embodiments described below. Further, the effects mentioned in the example embodiments described below are examples of the effects expected in the example embodiments described below, and are not intended to define an extension of the present invention. That is, the present invention can also encompass, in its scope, any example embodiment that does not bring about any of the effects mentioned in the example embodiments described below.

### First Example Embodiment

The following description will discuss a first example embodiment, which is an example of an embodiment of the present invention, in detail, with reference to the drawings. The present example embodiment is a basic form of the example embodiments described later. Note that the scope of application of technical means which are employed in the present example embodiment is not limited to the present example embodiment. That is, the technical means which are employed in the present example embodiment can be employed also in the other example embodiments included in the present disclosure, within a range in which no particular technical problem occurs. Moreover, technical means which are indicated in the drawings referred to for describing the present example embodiment can be employed also in the other example embodiments included in the present disclosure, within a range in which no particular technical problem occurs.

### (Configuration of Information Processing Apparatus 1)

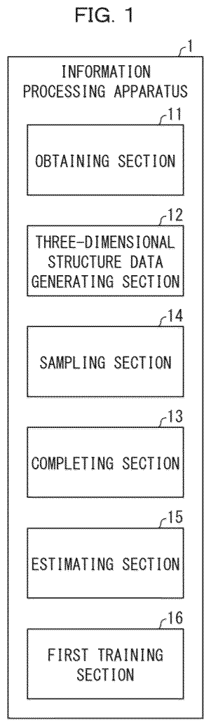

A configuration of an information processing apparatus 1 in accordance with the present example embodiment is described with reference to FIG. 1. FIG. 1 is a block diagram illustrating the configuration of the information processing apparatus 1. The information processing apparatus 1 includes, as illustrated in FIG. 1, an obtaining section 11, a three-dimensional structure data generating section 12, a sampling section 14, a completing section 13, an estimating section 15, and a first training section 16.

### (Obtaining Section 11)

The obtaining section 11 obtains input data. Note, here, that the input data is, as an example, input data for a training phase. Specific examples of the input data obtained by the obtaining section 11 do not limit the present example embodiment, but the input data can be configured to include, as an example, at least any of:
RGB data in which each pixel (data point) expresses an RGB value;
depth data in which each pixel (data point) expresses a depth value; and
three-dimensional point cloud data in which each data point expresses three-dimensional coordinates.
   The three-dimensional point cloud data can be, as an example, point cloud data obtained by a light detection and ranging or laser imaging detection and ranging (LiDAR) apparatus, but this example does not limit the present example embodiment.

### (Three-Dimensional Structure Data Generating Section 12)

The three-dimensional structure data generating section 12 generates three-dimensional structure data from the input data which has been obtained by the obtaining section 11. As an example, the three-dimensional structure data generating section 12 generates the three-dimensional structure data from the input data which has been obtained by the obtaining section 11 and which includes at least any of the RGB data and the depth data. As an example, the three-dimensional structure data generating section 12 can be configured to:
specify the three-dimensional coordinates of each pixel which is included in the RGB data, with reference to the depth value of each pixel in the depth data; and
generate the three-dimensional structure data in which the specified three-dimensional coordinates are assigned to each pixel (each data point).
   Note, here, that the three-dimensional structure data may be configured to include a feature value of each data point, in addition to the three-dimensional coordinates assigned to each data point. Note, here, that each feature value may be configured to include at least any of the RGB value and a normal value (normal vector) of each data point. Alternatively, the three-dimensional structure data generating section 12 may be configured to generate attribute data which includes the feature value (for example, at least any of the RGB value and the normal value (normal vector)) of each data point, concomitantly with the three-dimensional structure data which includes the three-dimensional coordinates of each data point.

The three-dimensional structure data generating section 12 may generate the three-dimensional structure data with use of an algorithm such as structure from motion (SfM) or simultaneous localization and mapping (SLAM).

With the above-described configuration, the three-dimensional structure data generating section 12 is capable of generating the three-dimensional structure data from one or more frames (one or more data sets) included in the input data which has been obtained by the obtaining section 11.

In a case where the obtaining section 11 obtains the input data which includes the three-dimensional point cloud data, the three-dimensional structure data generating section 12 may be configured to output the three-dimensional point cloud data as it is as the three-dimensional structure data. Alternatively, the three-dimensional structure data generating section 12 may be configured to include, in the three-dimensional point cloud data, the above-described feature value (for example, at least any of the RGB value and the normal value (normal vector)) of each data point and output the three-dimensional point cloud data as the three-dimensional structure data. Alternatively, the three-dimensional structure data generating section 12 may be configured to output the attribute data which includes the above-described feature value of each data point, concomitantly with the three-dimensional structure data which includes the three-dimensional coordinates of each data point.

Note that in a case where the obtaining section 11 obtains the input data which includes the three-dimensional point cloud data and a case where the three-dimensional structure data generating section 12 is configured to output the three-dimensional point cloud data as it is as the three-dimensional structure data, the information processing apparatus 1 may be configured not to include the three-dimensional structure data generating section 12. Such a configuration is also encompassed in the present example embodiment.

### (Sampling Section 14)

The sampling section 14 generates sampled three-dimensional structure data by sampling the three-dimensional structure data which has been generated by the three-dimensional structure data generating section 12. Note, here, that the above sampling process includes, as an example,
a process of generating the sampled three-dimensional structure data with use of only some of a plurality of frames included in the input data.
   Alternatively, the sampling process may be configured to include
a process of generating the sampled three-dimensional structure data with use of only some of a plurality of data points included in at least any of the input data and the three-dimensional structure data.
   Note that the sampling process executed by the sampling section 14 may be referred to as a thinning process. Therefore, the sampled three-dimensional structure data may also be referred to as, for example, thinned three-dimensional structure data.

### (Completing Section 13)

The completing section 13 applies a completing process to the sampled three-dimensional structure data which has been generated by the sampling section 14. Note, here, that the completing process can include a process of estimating (generating) a region which has been completed (also referred to as a completed region or a completed structure) with regard to an occluded part or a missing part in the sampled three-dimensional structure data. The completing process is executed with use of a completion model which can be subjected to machine learning. More specifically, as an example, the completing process is carried out by inputting the sampled three-dimensional structure data into a neural network which is a completion model having a plurality of layers. The neural network into which the sampled three-dimensional structure data has been inputted outputs completed three-dimensional structure data.

An intermediate feature value which has been generated (computed) in the completing process executed by the completing section 13 (as an example, feature value generated (computed) in an intermediate layer of the neural network) is referred to by the estimating section 15 (described later). A specific configuration of the completing section 13 does not limit the present example embodiment, but, as an example, the completing section 13 may be configured to include:
an encoder into which the sampled three-dimensional structure data is inputted and which outputs the intermediate feature value; and
a decoder into which the intermediate feature value is inputted and which outputs the completed three-dimensional structure data.

### (Estimating Section 15)

The estimating section 15 executes a shape estimating process in which the intermediate feature value in the completing process executed by the completing section 13 is referred to. As an example, the estimating section 15 carries out the shape estimating process by computing each value of a distance function from the intermediate feature value. In other words, the estimating section 15 expresses a result of the shape estimating process as a distance function. Note, here, that the distance function indicates, as an example, a function defined by a distance from a certain point in a space to each point in a target object. For example, in a signed distance function (SDF), which is an example of the distance function, a space is expressed by the minimum distance from a certain point to a surface of a target object. In a case where the point is located inside the target object, a negative value is assigned. In a case where the point is located outside the target object, a positive value is assigned. Therefore, in this case, the surface (contour) of the target object is expressed by a region (contour) in which a value of the SDF is zero. Such a surface that is defined by SDF=0 is also referred to as an implicit surface. Note that an example of the distance function is not limited to the above-described SDF, and an unsigned distance function (UDF) may be used. As an example, a value of the UDF is positive, and the surface (contour) of the target object is expressed by a region (contour) in which the value of the UDF is a given value.

Note that a specific process executed by the estimating section 15 does not limit the present example embodiment, but the estimating section 15 may be configured to, as an example, execute:
a feature value converting process of converting the intermediate feature value in the completing process into a latent variable; and
the shape estimating process in which the latent variable and the sampled three-dimensional structure data are referred to.

### (First Training Section 16)

The first training section 16 trains the completing section 13 (machine learning) with reference to a first loss value which is a loss value pertaining to a shape that has been obtained by the shape estimating process executed by the estimating section 15. Note, here, that the first loss value may be, as an example, a value which indicates a difference between
each value of the distance function which has been obtained by the shape estimating process executed by the estimating section 15 and
each value of a distance function which has been obtained with reference to the sampled three-dimensional structure data generated by the sampling section 14 (i.e., each value of a distance function which has been obtained from the three-dimensional structure data that has not been subjected to the processes executed by the completing section 13 and the estimating section 15).
   The first training section 16 then trains the completing section 13 so that, as an example, the first loss value becomes lower.

### (Effect of Information Processing Apparatus 1)

As has been described, the information processing apparatus 1 employs a configuration such that:
the input data is obtained;
the three-dimensional structure data is generated from the input data;
the sampled three-dimensional structure data is generated by sampling the three-dimensional structure data;
the completing process executed by the completing section 13 is applied to the sampled three-dimensional structure data;
the shape estimating process in which the intermediate feature value in the completing process is referred to is executed; and
the completing section 13 is trained with reference to the first loss value which is a loss value pertaining to the shape that has been obtained by the shape estimating process.
   According to the above configuration, the shape estimating process in which the intermediate feature value in the completing process is referred to is executed, and the completing section 13 is trained with reference to the first loss value which is a loss value pertaining to the shape that has been obtained by the shape estimating process. Therefore, it is possible to suitably improve the ability of the completing process executed by the completing section 13. Therefore, according to the above configuration, it is possible to provide a three-dimensional shape completing method in which the ability of expressing a space is improved.

### (Additional Remarks on Information Processing Apparatus 1)

As has been described, in a case where the obtaining section 11 is configured to obtain the three-dimensional point cloud data, the information processing apparatus 1 may be configured not to include the three-dimensional structure data generating section 12. In other words, the information processing apparatus 1 may be configured to include:
the obtaining section 11 which obtains the input data that includes the three-dimensional point cloud data;
the sampling section 14 which generates the sampled three-dimensional structure data by sampling the three-dimensional point cloud data (three-dimensional structure data);
the completing section 13 which applies the completing process to the sampled three-dimensional structure data;
the estimating section 15 which executes the shape estimating process in which the intermediate feature value in the completing process is referred to; and
the first training section 16 which trains the completing section 13 with reference to the first loss value which is a loss value pertaining to the shape that has been obtained by the shape estimating process. The information processing apparatus 1 configured in this manner is also capable of bringing about the above-described effect.

### (Flow of Information Processing Method S1)

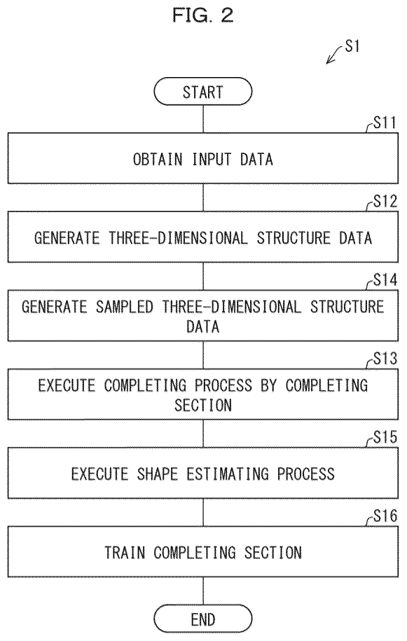

Next, a flow of an information processing method S1 in accordance with the present example embodiment is described with reference to FIG. 2. FIG. 2 is a flowchart illustrating the flow of the information processing method S1. As illustrated in FIG. 2, the information processing method S1 includes: a step (process) S11 of obtaining the input data; a step (process) S12 of generating the three-dimensional structure data; a step (process) S14 of generating the sampled three-dimensional structure data; a step (process) S15 of executing the completing process with use of the completing section (completion model); a step (process) S16 of executing the shape estimating process; and a step (process) S17 of training the completing section (completion model).

### (Step S11)

In the step S11, the obtaining section 11 obtains the input data. A specific process carried out by the obtaining section 11 has been described above, and therefore description thereof is omitted here.

### (Step S12)

Next, in the step S12, the three-dimensional structure data generating section 12 generates the three-dimensional structure data from the input data which has been obtained by the obtaining section 11 in the step S11. A specific process carried out by the three-dimensional structure data generating section 12 has been described above, and therefore description thereof is omitted here.

### (Step S14)

Next, in the step S14, the sampling section 14 generates the sampled three-dimensional structure data by sampling the three-dimensional structure data which has been generated by the three-dimensional structure data generating section 12 in the step S13. A specific process carried out by the sampling section 14 has been described above, and therefore description thereof is omitted here.

### (Step S13)

Next, in the step S13, the completing section 13 applies the completing process to the sampled three-dimensional structure data which has been generated by the sampling section 14 in the step S14. A specific process carried out by the completing section 13 has been described above, and therefore description thereof is omitted here.

### (Step S15)

Next, in the step S15, the estimating section 15 executes the shape estimating process in which the intermediate feature value in the completing process executed by the completing section 13 in the step S13 is referred to. A specific process carried out by the estimating section 15 has been described above, and therefore description thereof is omitted here.

### (Step S16)

Next, in the step S16, the first training section 16 trains the completing section 13 (completion model) with reference to the first loss value which is a loss value pertaining to the shape that has been obtained by the shape estimating process executed by the estimating section 15 in the step S15. A specific process carried out by the first training section 16 has been described above, and therefore description thereof is omitted here.

### (Effect of Information Processing Method S1)

As has been described, the information processing method S1 employs a configuration such that:
the input data is obtained;
the three-dimensional structure data is generated from the input data;
the sampled three-dimensional structure data is generated by sampling the three-dimensional structure data;
the completing process executed by the completing section 13 (completion model) is applied to the sampled three-dimensional structure data;
the shape estimating process in which the intermediate feature value in the completing process is referred to is executed; and
the completing section 13 (completion model) is trained with reference to the first loss value which is a loss value pertaining to the shape that has been obtained by the shape estimating process.
   According to the above configuration, the shape estimating process in which the intermediate feature value in the completing process is referred to is executed, and the completing section 13 (completion model) is trained with reference to the first loss value which is a loss value pertaining to the shape that has been obtained by the shape estimating process. Therefore, it is possible to suitably improve the ability of the completing process executed by the completing section 13 (completion model). Therefore, according to the above configuration, it is possible to provide a three-dimensional shape completing method in which the ability of expressing a space is improved.

### (Additional Remarks on Information Processing Method S1)

In a case where the obtaining section 11 is configured to obtain the three-dimensional point cloud data in the step S11, the information processing method S1 may be configured not to include the step S12. In other words, the information processing method S1 may be configured to include:
the step S11 of obtaining the input data that includes the three-dimensional point cloud data;
the step S14 of generating the sampled three-dimensional structure data by sampling the three-dimensional point cloud data (three-dimensional structure data);
the step S13 of applying, to the sampled three-dimensional structure data, the completing process executed by the completing section 13 (completion model);
the step S15 of executing the shape estimating process in which the intermediate feature value in the completing process is referred to; and
the step S16 of training the completing section 13 (completion model) with reference to the first loss value which is a loss value pertaining to the shape that has been obtained by the shape estimating process.
   The information processing method S1 configured in this manner is also capable of bringing about the above-described effect.

### (Configuration of Information Processing Apparatus 2)

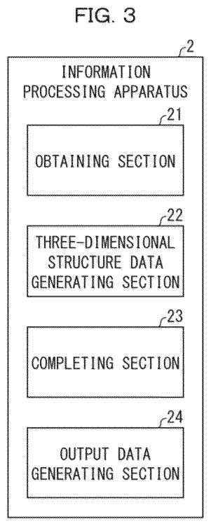

Next, a configuration of an information processing apparatus 2 in accordance with the present example embodiment is described with reference to FIG. 3. FIG. 3 is a block diagram illustrating the configuration of the information processing apparatus 2. The information processing apparatus 2 includes, as illustrated in FIG. 3, an obtaining section 21, a three-dimensional structure data generating section 22, a completing section 23, and an output data generating section 24.

### (Obtaining Section 21)

The obtaining section 21 obtains input data. Note, here, that the input data is, as an example, input data for an inferring phase (estimating phase, test phase). Specific examples of the input data obtained by the obtaining section 21 do not limit the present example embodiment, but the input data can be configured to include, as an example, at least any of:
RGB data in which each pixel (data point) expresses an RGB value;
depth data in which each pixel (data point) expresses a depth value; and
three-dimensional point cloud data in which each data point expresses three-dimensional coordinates.
   The three-dimensional point cloud data can be, as an example, point cloud data obtained by a light detection and ranging or laser imaging detection and ranging (LiDAR) apparatus, but this example does not limit the present example embodiment.

### (Three-Dimensional Structure Data Generating Section 22)

The three-dimensional structure data generating section 22 generates three-dimensional structure data from the input data which has been obtained by the obtaining section 21. As an example, the three-dimensional structure data generating section 22 generates the three-dimensional structure data from the input data which has been obtained by the obtaining section 21 and which includes at least any of the RGB data and the depth data. As an example, the three-dimensional structure data generating section 22 can be configured to:
specify the three-dimensional coordinates of each pixel which is included in the RGB data, with reference to the depth value of each pixel in the depth data; and
generate the three-dimensional structure data in which the specified three-dimensional coordinates are assigned to each pixel (each data point).
   Note, here, that the three-dimensional structure data may be configured to include at least any of the RGB value and a normal value (normal vector) of each data point, in addition to the three-dimensional coordinates assigned to each data point. Alternatively, the three-dimensional structure data generating section 22 may be configured to generate attribute data which includes at least any of the RGB value and the normal value (normal vector) of each data point, concomitantly with the three-dimensional structure data which includes the three-dimensional coordinates of each data point.

In a case where the obtaining section 21 obtains the input data which includes the three-dimensional point cloud data, the three-dimensional structure data generating section 22 may be configured to output the three-dimensional point cloud data as it is as the three-dimensional structure data. Alternatively, the three-dimensional structure data generating section 22 may be configured to include, in the three-dimensional point cloud data, at least any of the above-described RGB value and normal value (normal vector) of each data point and output the three-dimensional point cloud data as the three-dimensional structure data. Alternatively, the three-dimensional structure data generating section 22 may be configured to output attribute data which includes at least any of the above-described RGB value and normal value (normal vector) of each data point, concomitantly with the three-dimensional structure data which includes the three-dimensional coordinates of each data point.

Note that, in a case where the obtaining section 21 obtains the input data which includes the three-dimensional point cloud data and a case where the three-dimensional structure data generating section 22 is configured to output the three-dimensional point cloud data as it is, the information processing apparatus 2 may be configured not to include the three-dimensional structure data generating section 22. Such a configuration is also encompassed in the present example embodiment.

In this manner, the three-dimensional structure data generating section 22 can be configured, as an example, to carry out a process similar to that carried out by the three-dimensional structure data generating section 12 included in the information processing apparatus 1. However, this does not limit the present example embodiment.

### (Completing Section 23)

The completing section 23 applies a completing process to the three-dimensional structure data which has been generated by the three-dimensional structure data generating section 22. Note, here, that the completing process can include a process of estimating (generating) a region which has been completed (also referred to as a completed region or a completed structure) with regard to an occluded part or a missing part in the three-dimensional structure data. The completing process is executed with use of a completion model (completing section) which has been subjected to machine learning. More specifically, the completing process is executed with use of, as the completion model (completing section), a completion model (completing section) which has been trained by:
a sampling process of generating sampled three-dimensional structure data by sampling three-dimensional structure data generated from training data;
a completing process executed by the completing section (completion model) with respect to the sampled three-dimensional structure data;
a shape estimating process in which an intermediate feature value in the completing process is referred to; and
a first training process of training the completion model (completing section) with reference to a first loss value which is a loss value pertaining to a shape that has been obtained by the shape estimating process.
   As the completing section (completion model) which has been trained in this manner, it is possible to use the completing section 13 which is included in the above-described information processing apparatus 1 and which has been trained by the first training section 16. However, this does not limit the present example embodiment.

### (Output Data Generating Section 24)

The output data generating section 24 generates output data from the three-dimensional structure data to which the completing process executed by the completing section 23 has been applied (completed three-dimensional structure data). As an example, the output data generating section 24 may generate the output data with reference to each value of a distance function computed with respect to the completed three-dimensional structure data. As an example, the output data generating section 24 may be configured to (i) reconstruct, as a three-dimensional structure by a marching cube method, a region of a surface which is in a voxel space that includes each value of the distance function computed with respect to the completed three-dimensional structure data and on which a value of the distance function is zero and (ii) generate the output data including the reconstructed data. The output data which has been generated by the output data generating section 24 is, as an example, presented to a user as a displayed image.

### (Effect of Information Processing Apparatus 2)

As has been described, the information processing apparatus 2 employs a configuration such that:
the input data is obtained;
the three-dimensional structure data is generated from the input data;
the completing process executed by the completing section (completion model) is applied to the three-dimensional structure data; and
the output data is generated from the three-dimensional structure data to which the completing process has been applied,
the completing section (completion model) being a section (model) which has been trained by:
   the sampling process of generating the sampled three-dimensional structure data by sampling the three-dimensional structure data generated from the training data;
   the completing process executed by the completing section (completion model) with respect to the sampled three-dimensional structure data;
   the shape estimating process in which the intermediate feature value in the completing process is referred to; and
   the first training process of training the completing section (completion model) with reference to the first loss value which is a loss value pertaining to the shape that has been obtained by the shape estimating process.
      According to the above configuration, used is the completing section (completion model) which has been trained by (i) the shape estimating process in which the intermediate feature value in the completing process is referred to and (ii) the first training process of training the completing section (completion model) with reference to the first loss value which is a loss value pertaining to the shape that has been obtained by the shape estimating process. Therefore, the output data is generated with use of the completing section (completion model) in which the ability of the completing process is suitably improved. Therefore, according to the above configuration, it is possible to provide a three-dimensional shape completing method in which the ability of expressing a space is improved.

### (Additional Remarks on Information Processing Apparatus 2)

As has been described, in a case where the obtaining section 21 is configured to obtain the three-dimensional point cloud data, the information processing apparatus 2 may be configured not to include the three-dimensional structure data generating section 22. In other words, the information processing apparatus 2 may be configured to include:
the obtaining section 21 which obtains the input data that includes the three-dimensional point cloud data;
the completing section 23 which applies, to the three-dimensional structure data, the above-described completing process executed by the completing section (completion model); and
the output data generating section 24 which generates the output data from the three-dimensional structure data to which the completing process has been applied.
   The information processing apparatus 2 configured in this manner is also capable of bringing about the above-described effect.

### (Flow of Information Processing Method S2)

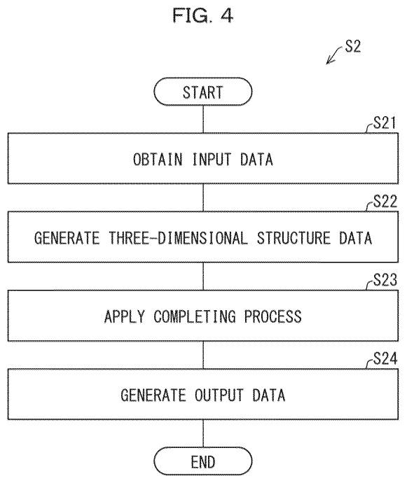

Next, a flow of an information processing method S2 in accordance with the present example embodiment is described with reference to FIG. 4. FIG. 4 is a flowchart illustrating the flow of the information processing method S2. As illustrated in FIG. 4, the information processing method S2 includes: a step (process) S21 of obtaining the input data; a step (process) S22 of generating the three-dimensional structure data; a step (process) S23 of executing the completing process; and a step (process) S24 of generating the output data.

### (Step S21)

In the step S21, the obtaining section 21 obtains the input data. A specific process carried out by the obtaining section 21 has been described above, and therefore description thereof is omitted here.

### (Step S22)

Next, in the step S22, the three-dimensional structure data generating section 22 generates the three-dimensional structure data from the input data which has been obtained by the obtaining section 21 in the step S21. A specific process carried out by the three-dimensional structure data generating section 22 has been described above, and therefore description thereof is omitted here.

### (Step S23)

Next, in the step S23, the completing section 23 applies the completing process to the three-dimensional structure data which has been generated by the three-dimensional structure data generating section 22 in the step S22. A specific process carried out by the completing section 23 has been described above, and therefore description thereof is omitted here.

### (Step S24)

Next, in the step S24, the output data generating section 24 generates the output data from the three-dimensional structure data to which the completing process executed by the completing section 23 has been applied in the step S23 (completed three-dimensional structure data). A specific process carried out by the output data generating section 24 has been described above, and therefore description thereof is omitted here.

### (Effect of Information Processing Method S2)

As has been described, the information processing method S2 employs a configuration such that:
the input data is obtained;
the three-dimensional structure data is generated from the input data;
the completing process executed by the completing section (completion model) is applied to the three-dimensional structure data; and
the output data is generated from the three-dimensional structure data to which the completing process has been applied,
the completing section (completion model) being a section (model) which has been trained by:
   the sampling process of generating the sampled three-dimensional structure data by sampling the three-dimensional structure data generated from the training data;
   the completing process executed by the completing section (completion model) with respect to the sampled three-dimensional structure data;
   the shape estimating process in which the intermediate feature value in the completing process is referred to; and
   the first training process of training the completing section (completion model) with reference to the first loss value which is a loss value pertaining to the shape that has been obtained by the shape estimating process.
      According to the above configuration, used is the completing section (completion model) which has been trained by (i) the shape estimating process in which the intermediate feature value in the completing process is referred to and (ii) the first training process of training the completing section (completion model) with reference to the first loss value which is a loss value pertaining to the shape that has been obtained by the shape estimating process. Therefore, the output data is generated with use of the completing section (completion model) in which the ability of the completing process is suitably improved. Therefore, according to the above configuration, it is possible to provide a three-dimensional shape completing method in which the ability of expressing a space is improved.

### (Additional Remarks on Information Processing Method S2)

In the case of a configuration in which the three-dimensional point cloud data is obtained in the step S21, the information processing method S2 may be configured not to include the step S22. In other words, the information processing method S2 may be configured to include:
the step S21 of obtaining the input data that includes the three-dimensional point cloud data;
the step S23 of applying, to the three-dimensional structure data, the completing process executed by the above-described completing section (completion model); and
the step S24 of generating the output data from the three-dimensional structure data to which the completing process has been applied.
   The information processing method S2 configured in this manner is also capable of bringing about the above-described effect.

### Second Example Embodiment

The following description will discuss a second example embodiment, which is an example of an embodiment of the present invention, in detail, with reference to the drawings. The same reference signs are given to constituent elements having the same functions as those of the constituent elements described in the foregoing example embodiment, and descriptions of the constituent elements are omitted as appropriate. Note that the scope of application of techniques which are employed in the present example embodiment is not limited to the present example embodiment. That is, the techniques which are employed in the present example embodiment can be employed also in the other example embodiments included in the present disclosure, within a range in which no particular technical problem occurs. Moreover, techniques indicated in the drawings referred to for describing the present example embodiment can be employed also in the other example embodiments included in the present disclosure, within a range in which no particular technical problem occurs.

### (Configuration of Information Processing Apparatus 100A)

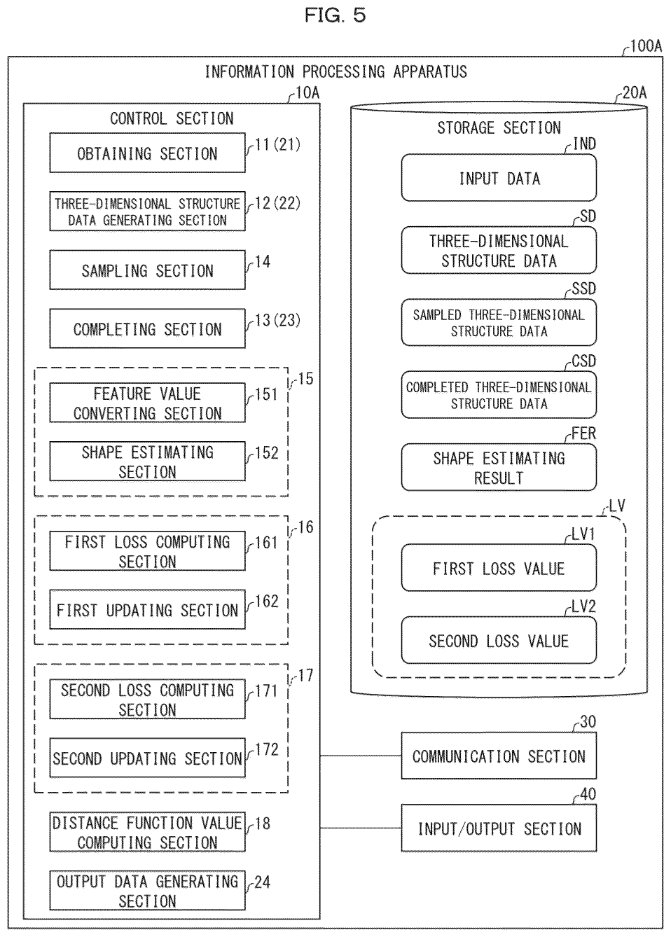

A configuration of an information processing apparatus 100A in accordance with the present example embodiment is described with reference to FIG. 5. FIG. 5 is a block diagram illustrating the configuration of the information processing apparatus 100A. As illustrated in FIG. 5, the information processing apparatus 100A includes a control section 10A, a storage section 20A, a communication section 30, and an input/output section 40.

### (Communication Section 30)

The communication section 30 carries out communication with an apparatus external to the information processing apparatus 100A via a network. As an example, the communication section 30 transmits, to the external apparatus, data supplied from the control section 10A, and supplies, to the control section 10A, data received from the external apparatus. Note that a specific configuration of the network does not limit the present example embodiment, but the network can be, as an example, a wireless local area network (LAN), a wired LAN, a wide area network (WAN), a public network, a mobile data communication network, or a combination of these networks.

### (Input/Output Section 40)

The input/output section 40 is configured to include at least any one of input/output apparatuses such as a keyboard, a mouse, a display, a printer, and touch panel. Alternatively, the input/output section 40 may be configured such that at least any one of the input/output apparatuses such as a keyboard, a mouse, a display, a printer, and touch panel is connected to the input/output section 40. In this configuration, the input/output section 40 accepts, from an input apparatus connected thereto, input of various pieces of information with respect to the information processing apparatus 100A. Further, the input/output section 40 outputs various pieces of information to an output apparatus connected thereto under control by the control section 10A. Examples of the input/output section 40 include interfaces such as a universal serial bus (USB).

### (Storage Section 20A)

In the storage section 20A, various pieces of data that are referred to by the control section 10A and various pieces of data that have been generated by the control section 10A are stored. As an example, in the storage section 20A, input data IND,
three-dimensional structure data SD,
sampled three-dimensional structure data SSD,
completed three-dimensional structure data CSD,
a shape estimating result FER,
a first loss value LV1,
a second loss value LV2, and
   the like are stored. Note, here, that the input data IND is data obtained by an obtaining section 11 (21) (described later). A specific example of the input data IND will be described later. The three-dimensional structure data SD is data generated by a three-dimensional structure data generating section 12 (22) (described later). A specific example of the three-dimensional point cloud data SD will be described later. The sampled three-dimensional structure data SSD is data generated by a sampling section 14 (described later). A specific example of the sampled three-dimensional structure data SSD will be described later. The completed three-dimensional structure data CSD is data generated by a completing section 13 (23) (described later). A specific example of the completed three-dimensional structure data CSD will be described later. The shape estimating result FER is a result of a shape estimating process executed by an estimating section 15 (described later). A specific example of the shape estimating result FER will be described later.

The first loss value LV1 is a loss value referred to by a first training section 16 (described later). A specific example of the first loss value LV1 will be described later. The second loss value LV2 is a loss value referred to by a second training section 17 (described later). A specific example of the second loss value LV2 will be described later. Note that the first loss value LV1 and the second loss value LV2 may be collectively simply referred to as a loss value LV.

### (Control Section 10A)

The control section 10A includes, as illustrated in FIG. 5, the obtaining section 11, the three-dimensional structure data generating section 12, the sampling section 14, the completing section 13, the estimating section 15, and the first training section 16 which have been described in the first example embodiment. Note, here, that the obtaining section 11 can also be expressed as having a configuration similar to that of the obtaining section 21 described in the first example embodiment. Therefore, the obtaining section 11 may also be referred to as an obtaining section 11 (21). The three-dimensional structure data generating section 12 can also be expressed as having a configuration similar to that of the three-dimensional structure data generating section 22 described in the first example embodiment. Therefore, the three-dimensional structure data generating section 12 may also be referred to as a three-dimensional structure data generating section 12 (22). The completing section 13 can also be expressed as having a configuration similar to that of the completing section 23 described in the first example embodiment. Therefore, the completing section 13 may also be referred to as a completing section 13 (23). The control section 10A also includes the second training section 17, a distance function value computing section 18, and an output data generating section 24, as illustrated in FIG. 5.

### (Obtaining Section 11 (21))

The obtaining section 11 (21) obtains the input data IND. Note, here, that, in a training phase, the obtaining section 11 (21) obtains the input data IND for training, whereas, in an inferring phase (estimating phase, test phase), the obtaining section 11 (21) obtains the input data IND for inference. Specific examples of the input data IND obtained by the obtaining section 11 (21) do not limit the present example embodiment, but the input data IND can be configured to, as in the first example embodiment, include, as an example, at least any of:
RGB data in which each pixel (data point) expresses an RGB value;
depth data in which each pixel (data point) expresses a depth value; and
three-dimensional point cloud data in which each data point expresses three-dimensional coordinates.
   The three-dimensional point cloud data can be, as an example, point cloud data obtained by a light detection and ranging or laser imaging detection and ranging (LiDAR) apparatus, but this example does not limit the present example embodiment.

The input data IND which has been obtained by the obtaining section 11 (21) is, as an example, stored in the storage section 20A, and referred to by the three-dimensional structure data generating section 12 (22), the sampling section 14, and the like.

### (Three-Dimensional Structure Data Generating Section 12 (22))

The three-dimensional structure data generating section 12 (22) generates the three-dimensional structure data SD from the input data IND which has been obtained by the obtaining section 11 (21). As an example, the three-dimensional structure data generating section 12 (22) generates the three-dimensional structure data SD from the input data IND which has been obtained by the obtaining section 11 (21) and which includes at least any of the RGB data and the depth data. As an example, the three-dimensional structure data generating section 12 (22) can be configured to:
specify the three-dimensional coordinates of each pixel which is included in the RGB data, with reference to the depth value of each pixel in the depth data; and
generate the three-dimensional structure data SD in which the specified three-dimensional coordinates are assigned to each pixel (each data point).
   Note, here, that, as in the first example embodiment, the three-dimensional structure data SD may be configured to include a feature value of each data point, in addition to the three-dimensional coordinates assigned to each data point. Note, here, that each feature value may be configured to include at least any of the RGB value and a normal value (normal vector) of each data point. Alternatively, the three-dimensional structure data generating section 12 (22) may be configured to generate attribute data which includes the feature value (for example, at least any of the RGB value and the normal value (normal vector)) of each data point, concomitantly with the three-dimensional structure data SD which includes the three-dimensional coordinates of each data point.

The three-dimensional structure data generating section 12 (22) may generate the three-dimensional structure data SD with use of an algorithm such as structure from motion (SfM) or simultaneous localization and mapping (SLAM).

With the above-described configuration, the three-dimensional structure data generating section 12 (22) is capable of generating the three-dimensional structure data SD from one or more frames (one or more data sets) included in the input data IND which has been obtained by the obtaining section 11 (21).

In a case where the obtaining section 11 (21) obtains the input data IND which includes the three-dimensional point cloud data, the three-dimensional structure data generating section 12 (22) may be configured to output the three-dimensional point cloud data as it is as the three-dimensional structure data SD. Alternatively, the three-dimensional structure data generating section 12 (22) may be configured to include, in the three-dimensional point cloud data, the above-described feature value (for example, at least any of the RGB value and the normal value (normal vector)) of each data point and output the three-dimensional point cloud data as the three-dimensional structure data SD. Alternatively, the three-dimensional structure data generating section 12 (22) may be configured to output the attribute data which includes the above-described feature value of each data point, concomitantly with the three-dimensional structure data SD which includes the three-dimensional coordinates of each data point.

Note that, in a case where the obtaining section 11 (21) obtains the input data IND which includes the three-dimensional point cloud data and a case where the three-dimensional structure data generating section 12 (22) is configured to output the three-dimensional point cloud data as it is as the three-dimensional structure data SD, the information processing apparatus 100A may be configured not to include the three-dimensional structure data generating section 12 (22). Such a configuration is also encompassed in the present example embodiment.

### (Sampling Section 14)

The sampling section 14 generates the sampled three-dimensional structure data SSD by sampling the three-dimensional structure data SD which has been generated by the three-dimensional structure data generating section 12 (22). Note, here, that the above sampling process includes, as an example,
a process of generating the sampled three-dimensional structure data SSD with use of only some of a plurality of frames included in the input data IND.
   As an example, the above sampling process can include
a process of generating the sampled three-dimensional structure data SSD with use of only N % (N is a real number of less than 100) of the plurality of frames included in the input data IND.
   Note, here, that, as a process of selecting N % of the plurality of frames, the sampling section 14 may carry out a process of
randomly selecting frames to be removed, or
collectively removing successive frames so that a specific region is missing in an image or a target object indicated by the input data IND.

Alternatively, the sampling process may be configured to include
a process of generating the sampled three-dimensional structure data SSD with use of only some of a plurality of data points which are included in at least any of the input data IND and the three-dimensional structure data SD.
   As an example, the above sampling process may be configured to include at least any of
a process of reducing the resolution of a depth image included in the input data IND, and
a process of applying, to the three-dimensional point cloud data included in the input data IND, a thinning method which causes the light receiving sensor density of the LiDAR apparatus to be low.

Note that the sampling process executed by the sampling section 14 may be referred to as a thinning process. Therefore, the sampled three-dimensional structure data SSD may also be referred to as, for example, thinned three-dimensional structure data.

### (Completing Section 13 (23))

In the training phase, the completing section 13 (23) applies a completing process to the sampled three-dimensional structure data SSD which has been generated by the sampling section 14. In the inferring phase, the completing section 13 (23) applies the completing process to the three-dimensional structure data SD which has been generated by the three-dimensional structure data generating section 12 (22).

Note, here, that the completing process can include a process of estimating (generating) a region which has been completed (also referred to as a completed region or a completed structure) with regard to an occluded part or a missing part in the sampled three-dimensional structure data SSD or the three-dimensional structure data SD. The completing process is executed with use of a completion model which can be subjected to machine learning. More specifically, as an example, the completing process is carried out by inputting the sampled three-dimensional structure data SSD or the three-dimensional structure data SD into a neural network which is a completion model having a plurality of layers. The neural network into which the sampled three-dimensional structure data SSD or the three-dimensional structure data SD has been inputted outputs the completed three-dimensional structure data CSD.

An intermediate feature value which has been generated (computed) in the completing process executed by the completing section 13 (23) (as an example, a feature value generated (computed) in an intermediate layer of the neural network) is referred to by the estimating section 15 (described later) in the training phase. A specific configuration of the completing section 13 (23) does not limit the present example embodiment, but, as an example, the completing section 13 may be configured to include:
an encoder into which the sampled three-dimensional structure data SSD or the three-dimensional structure data SD is inputted and which outputs the intermediate feature value; and
a decoder into which the intermediate feature value is inputted and which outputs the completed three-dimensional structure data CSD.
   A more specific configuration of the completing section 13 will be described later with reference to another drawing.

### (Estimating Section 15)

The estimating section 15 executes the shape estimating process with reference to the intermediate feature value in the completing process executed by the completing section 13, and derives the shape estimating result FER as a result of the shape estimating process. As an example, the estimating section 15 carries out the shape estimating process by computing each value of a distance function from the intermediate feature value. In other words, the estimating section 15 expresses the result of the shape estimating process as a distance function. Note, here, that the distance function indicates, as an example, a function defined by a distance from a certain point in a space to each point in a target object. For example, in a signed distance function (SDF), which is an example of the distance function, a space is expressed by the minimum distance from a certain point to a surface of a target object. In a case where the point is located inside the target object, a negative value is assigned. In a case where the point is located outside the target object, a positive value is assigned. Therefore, in this case, the surface (contour) of the target object is expressed by a region (contour) in which a value of the SDF is zero. Such a surface that is defined by SDF=0 is also referred to as an implicit surface.

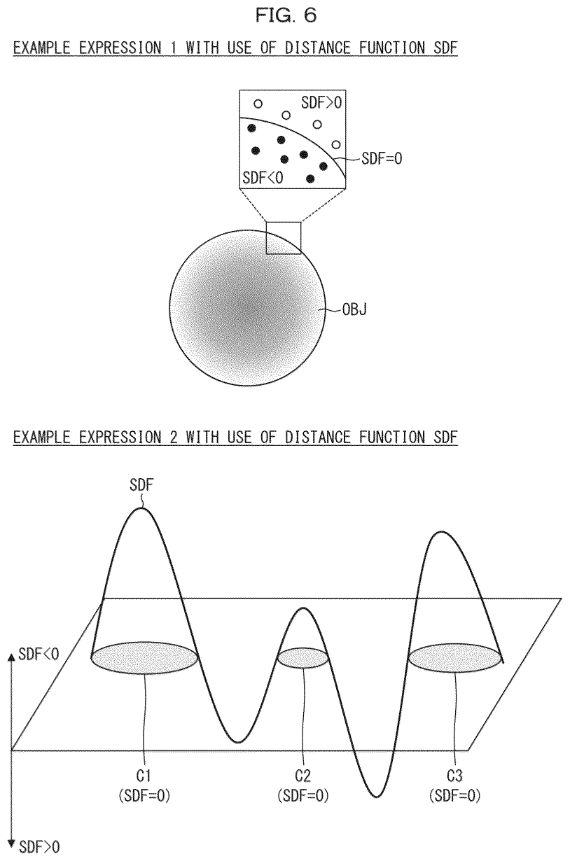

The upper part of FIG. 6 illustrates an example expression 1 of (i) the distance function SDF which is computed in the shape estimating process executed by the estimating section 15 and (ii) a target object with use of the distance function SDF. In this example, an SDF value indicating the inside of the target object OBJ is computed as a negative value, and an SDF value indicating the outside of the target object OBJ is computed as a positive value. The surface (contour) of the target object OBJ is then expressed (defined) by an implicit surface defined by SDF=0.

The lower part of FIG. 6 illustrates an example expression 2 of (i) the distance function SDF which is computed in the shape estimating process executed by the estimating section 15 and (ii) a target object with use of the distance function SDF. In this example, a certain multidimensional function gives an SDF value to a space. The SDF value which is positive indicates the outside of the object, and the SDF value which is negative indicates the inside the object. A cut surface (C1, C2, and C3 in the lower part of FIG. 6) in a case where SDF=0 indicates a surface of the object.

Note that, as in the first example embodiment, an example of the distance function is not limited to the above SDF, and may be an unsigned distance function (UDF). As an example, a value of the UDF is positive, and the surface (contour) of the target object is expressed by a region (contour) in which the value of the UDF takes a given value.

In this manner, the estimating section 15 executes the shape estimating process with use of the distance function, and the shape estimating result FER is expressed by the distance function. Therefore, it is possible to execute a three-dimensional shape completing process in which the ability of expressing a space is improved.

Note that, as illustrated in FIG. 5, the estimating section 15 may be configured to, as an example, include:
a feature value converting section 151 which converts the intermediate feature value in the completing process into a latent variable; and
a shape estimating section 152 which executes the shape estimating process in which the latent variable and the sampled three-dimensional structure data are referred to.
   A more specific configuration of the estimating section 15 will be described later with reference to another drawing.

### (First Training Section 16)

The first training section 16 trains the completing section 13 (23) with reference to the first loss value LV1 which is a loss value pertaining to a shape that has been obtained by the shape estimating process executed by the estimating section 15 (shape estimating result FER). Note, here, that the first loss value LV1 may be, as an example, a value which indicates a difference between
each value of the distance function which has been obtained by the shape estimating process executed by the estimating section 15 and
each value of a distance function which has been computed by the distance function value computing section 18 (described later) with reference to the sampled three-dimensional structure data SSD generated by the sampling section 14 (i.e., each value of a distance function which has been obtained from the sampled three-dimensional structure data SSD that has not been subjected to the processes executed by the completing section 13 and the estimating section 15).
   The first training section 16 then trains the completing section 13 so that, as an example, the first loss value LV1 becomes lower.

As illustrated in FIG. 5, the first training section 16 may be configured to, as an example, include:
a first loss computing section 161 which computes the first loss value LV1; and
a first updating section 162 which, with reference to the first loss value LV1, updates one or more parameters that define the completing section 13 (23).
   Note, here, that the one or more parameters that define the completing section 13 (23) indicate one or more parameters that define the completion model which functions as the completing section 13 (23). As an example, in a case where the completing section 13 (23) is constituted by the above-described encoder and the above-described decoder, the first updating section 162 updates a value (s) of one or more parameters which define the encoder so that the first loss value LV1 becomes lower. The parameter(s) updated by the first updating section 162 is/are, as an example, stored in the storage section 20A, and referred to in a training process in the subsequent step or the estimating process in the inferring phase.

### (Second Training Section 17)

The second training section 17 trains the completing section 13 (23) with reference to the second loss value LV2 which indicates a difference between the completed three-dimensional structure data CSD that has been outputted by the completing section 13 (23) and the three-dimensional structure data SD that has been generated by the three-dimensional structure data generating section 12 (22). More specifically, the second training section 17 trains the encoder and the decoder which constitute the completing section 13 (23), with reference to the second loss value LV2 which indicates the difference between the completed three-dimensional structure data CSD that has been outputted by the decoder constituting the completing section 13 (23) and the three-dimensional structure data SD that has been generated by the three-dimensional structure data generating section 12 (22).

As illustrated in FIG. 5, the second training section 17 may be configured to, as an example, include:
a second loss computing section 171 which computes the second loss value LV2; and
a second updating section 172 which, with reference to the second loss value LV2, updates one or more parameters that define the completing section 13 (23).
   As an example, in a case where the completing section 13 (23) is constituted by the above-described encoder and the above-described decoder, the second updating section 172 updates a value(s) of one or more parameters which define the encoder and a value(s) of one or more parameters which define the decoder so that the second loss value LV2 becomes lower. The parameter(s) updated by the second updating section 172 is/are, as an example, stored in the storage section 20A, and referred to in the training process in the subsequent step or the estimating process in the inferring phase.

### (Distance Function Value Computing Section 18)

The distance function value computing section 18 computes each value of the distance function with reference to the sampled three-dimensional structure data SSD which has been generated by the sampling section 14. In other words, the distance function value computing section 18 computes each value of the distance function corresponding to the sampled three-dimensional structure data SSD which has not been subjected to the processes executed by the completing section 13 and the estimating section 15. Each value of the distance function which has been computed by the distance function value computing section 18 is referred to by the above-described first training section 16.

### (Output Data Generating Section 24)

The output data generating section 24 generates output data from the three-dimensional structure data to which the completing process executed by the completing section 13 (23) has been applied (completed three-dimensional structure data CSD). As an example, the output data generating section 24 may generate the output data with reference to each value of the distance function computed with respect to the completed three-dimensional structure data CSD. As an example, the output data generating section 24 may be configured to (i) reconstruct, as a three-dimensional structure by a marching cube method, a region of a surface which is in a voxel space that includes each value of the distance function computed with respect to the completed three-dimensional structure data CSD and on which a value of the distance function is zero and (ii) generate the output data including the reconstructed data. The output data which has been generated by the output data generating section 24 is, as an example, presented to a user as a displayed image via a display included in the input/output section 40. In other words, the output data generating section 24 also functions as a displaying means (display control means) for displaying the output data which has been generated by the output data generating section 24.

As has been described, the information processing apparatus 100A employs a configuration such that:
the input data IND is obtained;
the three-dimensional structure data SD is generated from the input data IND;
the sampled three-dimensional structure data SSD is generated by sampling the three-dimensional structure data SD;
the completing process executed by the completing section 13 is applied to the sampled three-dimensional structure data SSD;
the shape estimating process in which the intermediate feature value in the completing process is referred to is executed; and
the completing section 13 is trained with reference to the first loss value LV1 which is a loss value pertaining to the shape that has been obtained by the shape estimating process.
   According to the above configuration, the shape estimating process in which the intermediate feature value in the completing process is referred to is executed, and the completing section 13 is trained with reference to the first loss value LV1 which is a loss value pertaining to the shape that has been obtained by the shape estimating process. Therefore, it is possible to suitably improve the ability of the completing process executed by the completing section 13. Therefore, according to the above configuration, it is possible to provide a three-dimensional shape completing method in which the ability of expressing a space is improved.

Furthermore, as has been described, in the information processing apparatus 100A, the shape estimating process is executed with use of the distance function. Therefore, it is possible to further improve the ability of expressing a space.

Moreover, as has been described, in the information processing apparatus 100A, the second training section 17 trains the completing section 13 (23) with reference to the second loss value LV2 which indicates a difference between the completed three-dimensional structure data CSD that has been outputted by the completing section 13 (23) and the three-dimensional structure data SD that has been generated by the three-dimensional structure data generating section 12 (22). Therefore, it is possible to provide a more suitable three-dimensional shape completing method.

### (Flow of Data in Training Phase)

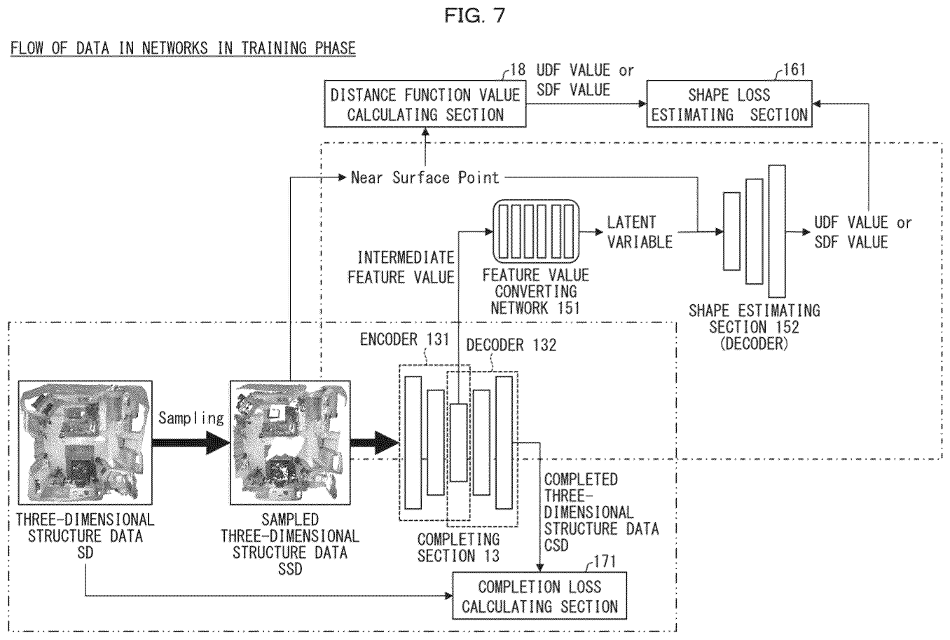

Next, a flow of data in the training phase of the information processing apparatus 100A is described with reference to FIG. 7. FIG. 7 is a diagram illustrating (i) an example configuration of a network constituting each section included in the information processing apparatus 100A and (ii) the flow of the data between these networks.

As illustrated in FIG. 7, the three-dimensional structure data SD which has been generated by the three-dimensional structure data generating section 12 (22) is converted into the sampled three-dimensional structure data SSD by the sampling process (indicated by “Sampling” in FIG. 7) executed by the sampling section 14. In the training phase, the sampled three-dimensional structure data SSD is then inputted into the completing section 13. Note, here, that, as illustrated in FIG. 7, the completing section 13 includes:
an encoder 131 into which the sampled three-dimensional structure data SSD is inputted and which outputs the intermediate feature value; and
a decoder 132 into which the intermediate feature value is inputted and which outputs the completed three-dimensional structure data CSD.

The completed three-dimensional structure data CSD is inputted into a completion loss calculating section 171 (corresponding to the above-described second loss computing section 171). The completion loss calculating section (second loss computing section) 171 computes the second loss value LV2 which indicates the difference between the three-dimensional structure data SD and the completed three-dimensional structure data CSD. The computed second loss value LV2 is referred to by the second updating section 172 so as to update a parameter(s) of the encoder 131 and the decoder 132.

On the other hand, the intermediate feature value which has been outputted by the encoder 131 is inputted into a feature value converting network 151 (corresponding to the above-described feature value converting section 151). The feature value converting network (feature value converting section) 151 is configured to include, as an example, a pooling layer and a fully-connected layer, and derives the latent variable from the intermediate feature value. The latent variable which has been derived by the feature value converting network (feature value converting section) 151 is inputted into the shape estimating section 152. Note, here, that the shape estimating section 152 has, as an example, a network configuration as a decoder. Furthermore, as illustrated in FIG. 7, together with the latent variable,
a point cloud near a surface in the sampled three-dimensional structure data SSD (indicated by “Near Surface Point” in FIG. 7), or
a point cloud which is near the surface and which is obtained by adding random noise to the sampled three-dimensional structure data SSD
   is inputted into the shape estimating section 152. The shape estimating section 152 then computes the above-described UDF value or the above-described SDF value as the shape estimating result FER. The UDF value or the SDF value which has been computed by the shape estimating section 152 is inputted into a shape loss estimating section 161 (corresponding to the above-described first loss computing section 161).

Meanwhile,
the above-described point cloud near the surface in the sampled three-dimensional structure data SSD, or
the above-described point cloud near the surface which is obtained by adding the random noise to the sampled three-dimensional structure data SSD
   is inputted into a distance function value calculating section (distance function value computing section) 18. With reference to these point clouds, the distance function value calculating section 18 computes a UDF value or an SDF value corresponding to the sampled three-dimensional structure data SSD. The UDF value or the SDF value which has been computed by the distance function value calculating section 18 is inputted into the shape loss estimating section 161 (corresponding to the above-described first loss computing section 161).

The shape loss estimating section (first loss computing section) 161 computes a first loss function value LV1 which indicates a difference between
the UDF value or the SDF value computed by the shape estimating section 152 and
the UDF value or the SDF value computed by the distance function value calculating section 18.
   The computed first loss function value LV1 is referred to by the first updating section 162 so as to update a parameter(s) of encoder 131.

### (Flow of Process in Training Phase)

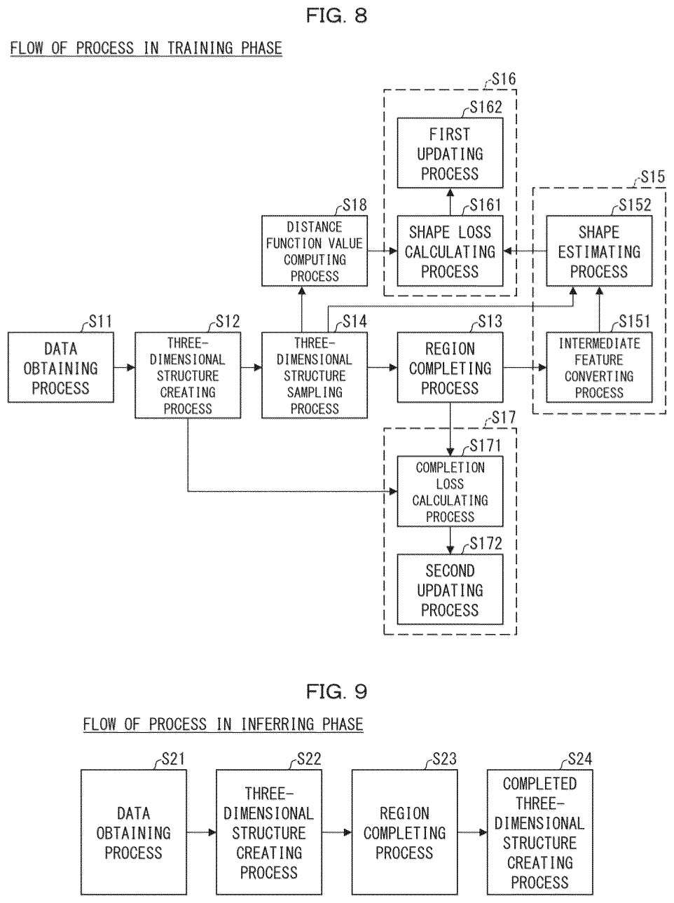

Next, a flow of a process in the training phase of the information processing apparatus 100A is described with reference to FIG. 8. FIG. 8 is a diagram illustrating the flow of the process in the training phase of the information processing apparatus 100A.

### (Step S11)

In a step S11, the obtaining section 11 executes a data obtaining process. As an example, the obtaining section 11 obtains the input data IND for training. A specific process carried out by the obtaining section 11 has been described above, and therefore description thereof is omitted here.

### (Step S12)

In a step S12, the three-dimensional structure data generating section 12 generates the three-dimensional structure data SD by a three-dimensional structure creating process. A specific process carried out by the three-dimensional structure data generating section 12 has been described above, and therefore description thereof is omitted here.

### (Step S14)

In a step S14, the sampling section 14 generates the sampled three-dimensional structure data SSD by applying a three-dimensional structure sampling process to the three-dimensional structure data SD. A specific process carried out by the sampling section 14 has been described above, and therefore description thereof is omitted here.

### (Step S13)

In a step S13, the completing section 13 generates the intermediate feature value and the completed three-dimensional structure data CSD by applying a region completing process to the sampled three-dimensional structure data SSD. A specific process carried out by the completing section 13 has been described above, and therefore description thereof is omitted here.

### (Step S151)

In a step S151, the feature value converting section 151 derives the latent variable by applying an intermediate feature converting process to the intermediate feature value which has been generated by the completing section 13. A specific process carried out by the feature value converting section 151 has been described above, and therefore description thereof is omitted here.

### (Step S152)

In a step S152, the shape estimating section 152 executes the shape estimating process with reference to the latent variable which has been derived by the feature value converting section 151. A specific process carried out by the shape estimating section 152 has been described above, and therefore description thereof is omitted here.

### (Step S18)

Meanwhile, in a step S18, the distance function value computing section 18 computes a distance function value corresponding to the sampled three-dimensional structure data SSD. A specific process carried out by the distance function value computing section 18 has been described above, and therefore description thereof is omitted here.

### (Step S161)

In a step S161, the first loss computing section 161 computes the first loss value LV1 by executing a shape loss calculating process with reference to the distance function value which has been computed by the distance function value computing section 18 and a distance function value which is indicated by the shape estimating result obtained by the shape estimating section 152. A specific process carried out by the first loss computing section 161 has been described above, and therefore description thereof is omitted here.

### (Step S162)

In a step S162, the first updating section 162 executes a process of updating the completing section 13 (first updating process) with reference to the first loss value LV1. A specific process carried out by the first updating section 162 has been described above, and therefore description thereof is omitted here.

### (Step S171)

Meanwhile, in a step S171, the second loss computing section 171 computes the second loss value LV2 by executing a completion loss calculating process with reference to the three-dimensional structure data SD and the completed three-dimensional structure data CSD. A specific process carried out by the second loss computing section 171 has been described above, and therefore description thereof is omitted here.

### (Step S172)

In a step S172, the second updating section 172 executes a process of updating the completing section 13 (second updating process) with reference to the second loss value LV2. A specific process carried out by the second updating section 172 has been described above, and therefore description thereof is omitted here.

A series of processes from the step S11 to the step S162 or the step S172 may be executed repeatedly, as an example, until a given convergence condition is satisfied. Note that, as an example, data which has been stopped by at least any of the processes from the step S11 to the step S162 or the step S172 may be configured to be presented to a user via the input/output section 40.

### (Flow of Process in Inferring Phase)

Next, a flow of a process in the inferring phase (estimating phase, test phase) of the information processing apparatus 100A is described with reference to FIG. 9. FIG. 9 is a diagram illustrating the flow of the process in the inferring phase of the information processing apparatus 100A.

### (Step S21)

In a step S21, the obtaining section 21 executes a data obtaining process. As an example, the obtaining section 21 obtains the input data IND for inference. A detailed process carried out by the obtaining section 21 has been described above, and therefore description thereof is omitted here.

### (Step S22)

Next, in a step S22, the three-dimensional structure data generating section 22 generates the three-dimensional structure data SD with reference to the input data IND for inference (three-dimensional structure creating process). A specific process carried out by the three-dimensional structure data generating section 22 has been described above, and therefore description thereof is omitted here.

### (Step S23)

Next, in a step S23, the completing section 23 generates the completed three-dimensional structure data CSD with reference to the three-dimensional structure data SD (region completing process). Note, here, that the completing section 23 is a section which has been trained by each process in the above-described inferring phase. A specific process carried out by the completing section 23 has been described above, and therefore description thereof is omitted here.

### (Step S24)

Next, in a step S24, the output data generating section 24 generates data for output from the completed three-dimensional structure data CSD (completed three-dimensional structure creating process). A specific process carried out by the output data generating section 24 has been described above, and therefore description thereof is omitted here.

### Third Example Embodiment

The following description will discuss a third example embodiment, which is an example of an embodiment of the present invention, in detail, with reference to the drawings. The same reference signs are given to constituent elements having the same functions as those of the constituent elements described in the foregoing example embodiment, and descriptions of the constituent elements are omitted as appropriate. Note that the scope of application of technical means which are employed in the present example embodiment is not limited to the present example embodiment. That is, the techniques which are employed in the present example embodiment can be employed also in the other example embodiments included in the present disclosure, within a range in which no particular technical problem occurs. Moreover, techniques indicated in the drawings referred to for describing the present example embodiment can be employed also in the other example embodiments included in the present disclosure, within a range in which no particular technical problem occurs.

### (Configuration of Information Processing Apparatus 100B)

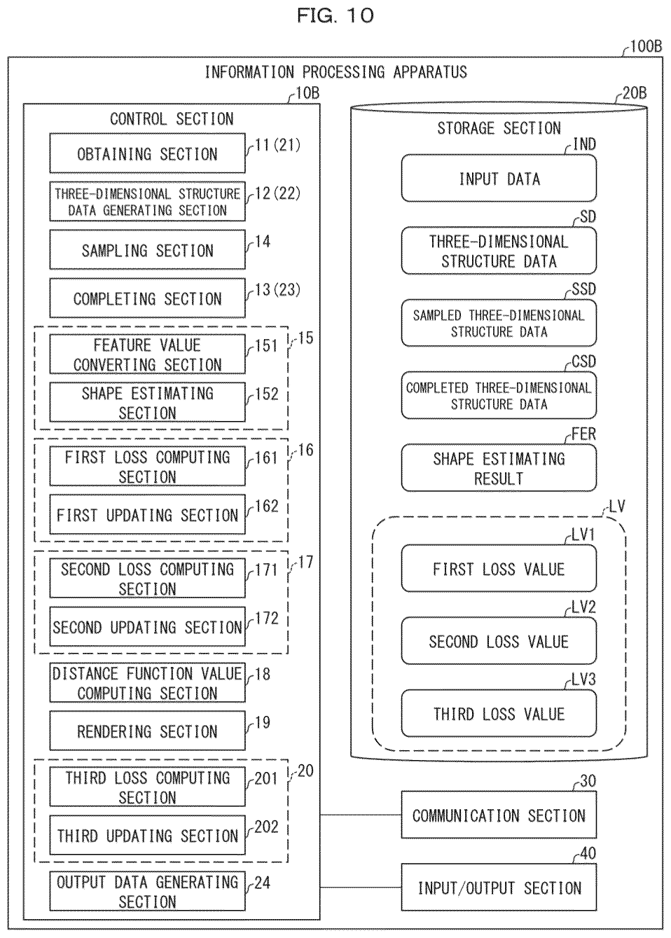

A configuration of an information processing apparatus 100B in accordance with the present example embodiment is described with reference to FIG. 10. FIG. 10 is a block diagram illustrating the configuration of the information processing apparatus 100B. As illustrated in FIG. 10, the information processing apparatus 100B includes a control section 10B, a storage section 20B, a communication section 30, and an input/output section 40.

### (Storage Section 20B)

In the storage section 20B, a third loss value LV3 is stored in addition to various pieces of data stored in the storage section 20A included in the information processing apparatus 100A in accordance with the second example embodiment. The third loss value LV3 will be described later.

(Control Section 10B) The control section 10B includes a rendering section 19 and a third training section 20, in addition to the configurations included in the information processing apparatus 100A in accordance with the second example embodiment. The following mainly describes points differing from the information processing apparatus 100A.

### (Obtaining Section 11 (21))

An obtaining section 11 (21) in accordance with the present example embodiment further obtains information pertaining to the position and orientation of an image capturing apparatus at a time when the image capturing apparatus captured an RGB image included in input data IND, in addition to the data obtained by the obtaining section 11 (21) in accordance with the second example embodiment.

### (Rendering Section 19)

The rendering section 19 executes a rendering process with reference to:
a shape indicated by a shape estimating result FER obtained by an estimating section 15; and
the information pertaining to the position and orientation of the image capturing apparatus at the time when the image capturing apparatus captured the RGB image included in the input data IND.

As an example, on the basis of the shape indicated by the shape estimating result FER obtained by the estimating section 15, the rendering section 19 executes a volume rendering process or a ray tracing process with use of the information pertaining to the position and orientation of the image capturing apparatus, thereby rendering (generating) an image (rendered image) on a given image plane.

### (Third Training Section 20)

The third training section 20 executes a training process in which the third loss value LV3 is referred to, the third loss value LV3 indicating a difference between the rendered image which has been obtained by the rendering process and the RGB image which is included in the input data.

As an example, as illustrated in FIG. 10, the third training section 20 includes:
a third loss computing section 201 which computes the third loss value LV3; and
a third updating section 202 which updates one or more parameters that define a completing section 13 (23), with reference to the third loss value LV3.
   As an example, the third updating section 202 updates the one or more parameters that define the completing section 13 (23) so that the third loss value LV3 becomes lower.

As has been described, according to the information processing apparatus 100B in accordance with the present example embodiment,
since the completing section 13 (23) is trained with reference to the third loss value LV3 that indicates the difference between the rendered image which has been obtained by the rendering process and the image which is included in the input data, it is possible to provide a three-dimensional shape completing method in which the ability of expressing a space is further improved.

### (Flow of Process Carried Out by the Information Processing Apparatus 100B)

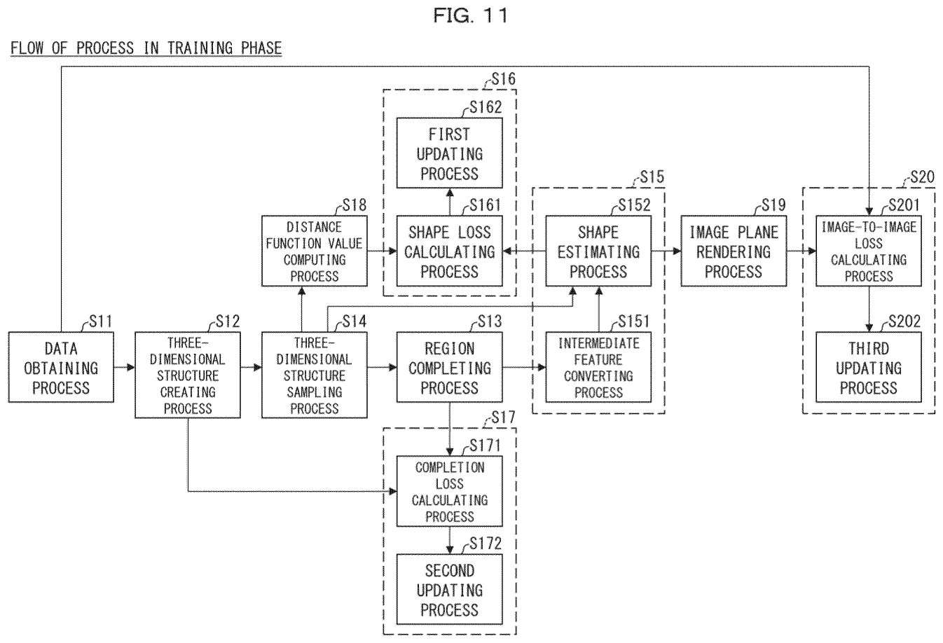

Next, a flow of a process carried out by the information processing apparatus 100B is described with reference to FIG. 11. FIG. 11 is a diagram illustrating the flow of the process carried out by the information processing apparatus 100B in a training phase. Note that a flow of a process carried out by the information processing apparatus 100B in an inferring phase is similar to that in the second example embodiment, and therefore description thereof is omitted.

As illustrated in FIG. 11, in the training phase, the information processing apparatus 100B executes processes in a step S19, S201, and S202, in addition to the processes executed by the information processing apparatus 100A.

### (Step S19)

In the step S19, the rendering section 19 executes a rendering process (plane image rendering process) with reference to a result of a shape estimating process executed by the estimating section 15 (shape estimating result FER). A specific process carried out by the rendering section 19 has been described above, and therefore description thereof is omitted here.

### (Step S201)

Next, in the step S201, the third loss computing section 201 computes the third loss value LV3 that indicates the difference between the rendered image which has been obtained by the rendering process in the step S19 and the RGB image which is included in the input data IND (image-to-image loss calculating process). A specific process carried out by the third loss computing section 201 has been described above, and therefore description thereof is omitted here.

### (Step S202)

Next, in the step S202, the third updating section 202 updates the one or more parameters that define the completing section 13 (23), with reference to the third loss value LV3. A specific process carried out by the third updating section 202 has been described above, and therefore description thereof is omitted here.

### Fourth Example Embodiment

The following description will discuss a fourth example embodiment, which is an example of an embodiment of the present invention, in detail, with reference to the drawings. The same reference signs are given to constituent elements having the same functions as those of the constituent elements described in the foregoing example embodiment, and descriptions of the constituent elements are omitted as appropriate. Note that the scope of application of technical means which are employed in the present example embodiment is not limited to the present example embodiment. That is, the techniques which are employed in the present example embodiment can be employed also in the other example embodiments included in the present disclosure, within a range in which no particular technical problem occurs. Moreover, techniques indicated in the drawings referred to for describing the present example embodiment can be employed also in the other example embodiments included in the present disclosure, within a range in which no particular technical problem occurs.

### (Configuration of Information Processing Apparatus 100C)

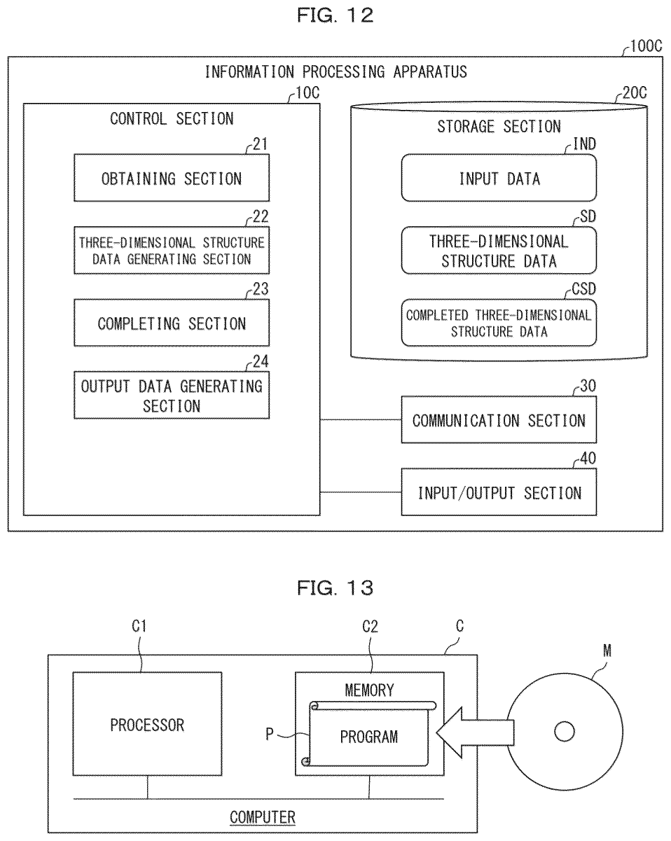

A configuration of an information processing apparatus 100C in accordance with the present example embodiment is described with reference to FIG. 12. FIG. 12 is a block diagram illustrating the configuration of the information processing apparatus 100C. As illustrated in FIG. 12, the information processing apparatus 100C includes a control section 10C, a storage section 20C, a communication section 30, and an input/output section 40.

### (Control Section 10C, Storage Section 20C)

The control section 10C includes the obtaining section 21, the three-dimensional structure data generating section 22, the completing section 23, and the output data generating section 24, but does not include the other configurations, among the configurations included in the control section 10A or 10B in accordance with the second or third example embodiment.

In the storage section 20C, the input data IND, the three-dimensional structure data SD, and the completed three-dimensional data CSD are stored, but the other data is not stored, among the data stored in the storage section 20A or 20B in accordance with the second or third example embodiment. Note, however, that one or more parameters that define a completion model used in a completing process executed by the completing section 23 are stored in the storage section 20C. The completion model is a model which has been trained (updated) by the processes in the training phase which are executed by the information processing apparatus 100A or 100B in accordance with the second or third example embodiment, as an example.

The information processing apparatus 100C having the above configuration includes:
the obtaining section 21 which obtains the input data IND;
the three-dimensional structure data generating section 22 which generates the three-dimensional structure data SD from the input data IND;
the completing section 23 which applies the completing process to the three-dimensional structure data SD; and
the output data generating section 24 which generates output data from the three-dimensional structure data to which the completing process has been applied,
   the completing section 23 being a section which has been trained by:
      a sampling process of generating sampled three-dimensional structure data by sampling three-dimensional structure data generated from training data;
      a completing process which is executed by the completing section with respect to the sampled three-dimensional structure data;
      a shape estimating process in which an intermediate feature value in the completing process is referred to; and
      a first training process of training the completing section with reference to a first loss value which is a loss value pertaining to a shape that has been obtained by the shape estimating process.

According to the above configuration, used is the completing section (completion model) which has been trained by (i) the shape estimating process in which the intermediate feature value in the completing process is referred to and (ii) the first training process of training the completing section (completion model) with reference to the first loss value which is a loss value pertaining to the shape that has been obtained by the shape estimating process. Therefore, output data is generated with use of the completing section (completion model) in which the ability of the completing process is suitably improved. Therefore, according to the above configuration, it is possible to provide a three-dimensional shape completing method in which the ability of expressing a space is improved.

### Example Application

The following describes example application of the information processing apparatus 1, 100A, 100B, or 100C in accordance with each example embodiment described above.

The information processing apparatus 1, 100A, 100B, or 100C (hereinafter, also simply referred to as an information processing apparatus 1 or the like) in accordance with each example embodiment described above can also be applied, as an example, to the medical and healthcare field. In this field, use of the technique of the present application enables medical application which is done by carrying out a three-dimensional shape completing process based on a captured medical image of a patient.

In a case where the information processing apparatus 1 or the like is applied to the medical and healthcare field, a process according to a process flow as described below, for example, may be carried out.

(Step S101: Scanning Step) A healthcare professional, such as a doctor, or a medical staff member uses an image capturing apparatus (such as an endoscope or a fMRI) to capture an image of a relevant region such as an organ (such as a stomach or a bowel) of a patient and generate a medical image. The medical image is then inputted, as the input data IND, into the information processing apparatus 1 or the like.

### (Step S102: 3D Modeling Step)

Next, the three-dimensional structure data generating section 12 (22) included in the information processing apparatus 1 or the like generates the three-dimensional structure data SD corresponding to the input data IND with reference to the input data IND. Note, here, that the three-dimensional structure data SD generated by the three-dimensional structure data generating section 12 (22) may be configured to be presented to the healthcare professional, the medical staff member, the patient, and/or the like, as an example, via a display or the like included in the input/output section 40. Note that the present step can be applied to both the training phase and the estimating phase.

### (Step S103A: Decision Making Step)

Next, the completing section 23 included in the information processing apparatus 1 or the like generates the completed three-dimensional structure data CSD by carrying out the three-dimensional shape completing process with respect to the medical image with use of the completion model which has been described in each example embodiment and which has been subjected to machine learning. The output data generating section 24 then generates the output data with reference to the completed three-dimensional structure data CSD, and outputs the output data via the input/output section 40. Note, here, that the completing section 23 included in the information processing apparatus 1 or the like may be configured to apply a segmenting process with respect to the completed three-dimensional structure data CSD and output a segmentation result. Note also that, as an example, the completing section 23 may be configured to carry out segmentation of a lesion region (inflammation, ulcer, polyp), a normal region, a site, and the like (region classification) by semantic segmentation. In this manner, by referring to the output data depending on the completed three-dimensional structure data CSD, it is possible for the healthcare professional to, for example, make a treatment plan. Therefore, it is possible for the present apparatus to assist the healthcare professional in making a decision on diagnosis.

### (Step S103B: Decision Making Step)

The information processing apparatus 1 or the like may carry out the following process, instead of or in addition to the process in the step S103A. That is, the completing section 23 of the information processing apparatus 1 or the like may present the completed three-dimensional structure data CSD to the healthcare professional, as an example, via the display or the like included in the input/output section 40. It is possible for the healthcare professional to, for example, understand the condition of the organ of the patient, by referring to the completed three-dimensional structure data CSD (3D model). Therefore, it is possible for the present apparatus to assist the healthcare professional in making a decision on diagnosis.

In this manner, in the present example application, the obtaining section 11 (21) of the information processing apparatus 1 or the like obtains the medical image as the input data, and the completing section 23 or the output data generating section 24 functions as a presenting means for displaying the output data for assisting the healthcare professional in making a decision.

### Software Implementation Example

Some or all of the functions of the information processing apparatuses 1, 100A, 100B, and 100C (hereinafter also referred to as “each apparatus”) may be implemented by hardware such as an integrated circuit (IC chip), or may be implemented by software.

In the latter case, the each apparatus is realized by, for example, a computer that executes the instructions of a program that is software realizing the functions. FIG. 13 illustrates an example of such a computer (hereinafter, referred to as “computer C”). FIG. 13 is a block diagram illustrating a hardware configuration of the computer C which functions as the each apparatus.

The computer C includes at least one processor C1 and at least one memory C2. In the memory C2, a program P for causing the computer C to operate as the each apparatus is recorded. In the computer C, the processor C1 retrieves the program P from the memory C2 and executes the program P, so that the functions of the each apparatus are implemented.

The processor C1 can be, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination of these. The memory C2 can be, for example, a flash memory, a hard disk drive (HDD), a solid state drive (SSD), or a combination of these.

Note that the computer C may further include a random access memory (RAM) in which the program P is loaded in a case where the program P is executed and in which various kinds of data are temporarily stored. The computer C may further include a communication interface via which the computer C transmits and receives data to and from another apparatus. The computer C may further include an input/output interface via which the computer C is connected to an input/output apparatus such as a keyboard, a mouse, a display, and a printer.

The program P can be recorded in a non-transitory tangible recording medium M which is readable by the computer C. Such a recording medium M can be, for example, a tape, a disk, a card, a semiconductor memory, a programmable logic circuit, or the like. The computer C can obtain the program P via the recording medium M. The program P can be transmitted via a transmission medium. The transmission medium can be, for example, a communications network, a broadcast wave, or the like. The computer C can obtain the program P also via such a transmission medium.

### Additional Remark A

The present disclosure includes techniques described in supplementary notes below. Note, however, that the present invention is not limited to the techniques described in the supplementary notes below, but may be altered in various ways by a skilled person within the scope of the claims.

### Supplementary Note A1

An information processing apparatus including:
an obtaining means for obtaining input data;
a three-dimensional structure data generating means for generating three-dimensional structure data from the input data;
a sampling means for generating sampled three-dimensional structure data by sampling the three-dimensional structure data;
a completing means for applying a completing process to the sampled three-dimensional structure data;
an estimating means for executing a shape estimating process in which an intermediate feature value in the completing process is referred to; and
a first training means for training the completing means with reference to a first loss value which is a loss value pertaining to a shape that has been obtained by the shape estimating process.

### Supplementary Note A2

The information processing apparatus described in Supplementary note A1, wherein:
the estimating means computes one or more distance function values in the shape estimating process; and
the first loss value is a loss value pertaining to the one or more distance function values.

### Supplementary Note A3

The information processing apparatus described in Supplementary note A1 or A2, wherein
the estimating means includes:
   a feature value converting means for converting the intermediate feature value in the completing process into a latent variable; and
   a shape estimating means for executing a shape estimating process with reference to the latent variable and the sampled three-dimensional structure data.

### Supplementary Note A4

The information processing apparatus described in any one of Supplementary notes A1 to A3, wherein:
the completing means includes
   an encoder into which the sampled three-dimensional structure data is inputted and which outputs the intermediate feature value, and
   a decoder into which the intermediate feature value is inputted and which outputs completed three-dimensional structure data; and
the first training means subjects the encoder to machine learning with reference to the first loss value.

### Supplementary Note A5

The information processing apparatus described in Supplementary note A4, including
a second training means for subjecting the encoder and the decoder to machine learning with reference to a second loss value that indicates a difference between the completed three-dimensional structure data which has been outputted by the decoder and the three-dimensional structure data which has been generated by the three-dimensional structure data generating means.

### Supplementary Note A6

The information processing apparatus described in any one of Supplementary notes A1 to A5, wherein:
the obtaining means further obtains information pertaining to a position and orientation of an image capturing apparatus at a time when the image capturing apparatus captured an RGB image included in the input data; and
the information processing apparatus includes a rendering means for executing a rendering process with reference to the shape which has been obtained by the shape estimating process and the information which pertains to the position and the orientation of the image capturing apparatus.

### Supplementary Note A7

The information processing apparatus described in Supplementary note A6, further including
a third training means for executing a training process in which a third loss value is referred to, the third loss value indicating a difference between a rendered image which has been obtained by the rendering process and the RGB image which is included in the input data.

### Supplementary Note A8

An information processing apparatus including:
an obtaining means for obtaining input data;
a three-dimensional structure data generating means for generating three-dimensional structure data from the input data;
a completing means for applying a completing process to the three-dimensional structure data; and
an output data generating means for generating output data from the three-dimensional structure data to which the completing process has been applied,
the completing means being a means which has been trained by:
   a sampling process of generating sampled three-dimensional structure data by sampling three-dimensional structure data generated from training data;
   a completing process which is executed by the completing means with respect to the sampled three-dimensional structure data;
   a shape estimating process in which an intermediate feature value in the completing process is referred to; and
   a first training process of training the completing means with reference to a first loss value which is a loss value pertaining to a shape that has been obtained by the shape estimating process.

### Supplementary Note A9

The information processing apparatus described in Supplementary note A8, including
a displaying means for displaying the output data which has been generated by the output data generating means.

### Supplementary Note A10

The information processing apparatus described in Supplementary note A9, wherein:
the obtaining means obtains a medical image as the input data; and
the displaying means displays the output data for assisting a healthcare professional in making a decision.

### Supplementary Note A12

An information processing apparatus executing:
obtaining input data;
generating three-dimensional structure data from the input data;
applying, to the three-dimensional structure data, a completing process which is executed by a completing means; and
generating output data from the three-dimensional structure data to which the completing process has been applied,
the completing means being a means which has been trained by:
   generating sampled three-dimensional structure data by sampling three-dimensional structure data generated from training data;
   applying, to the sampled three-dimensional structure data, a completing process which is executed by the completing means;
   executing a shape estimating process in which an intermediate feature value in the completing process is referred to; and
training the completing means with reference to a first loss value which is a loss value pertaining to a shape that has been obtained by the shape estimating process.

### Additional Remark B

The present disclosure includes techniques described in supplementary notes below. Note, however, that the present invention is not limited to the techniques described in the supplementary notes below, but may be altered in various ways by a skilled person within the scope of the claims.

### Supplementary Note B1

An information processing method including:
an obtaining step of obtaining input data;
a three-dimensional structure data generating step of generating three-dimensional structure data from the input data;
a sampling step of generating sampled three-dimensional structure data by sampling the three-dimensional structure data;
a completing step of applying a completing process to the sampled three-dimensional structure data;
an estimating step of executing a shape estimating process in which an intermediate feature value in the completing process is referred to; and
a first training step of training the completing step with reference to a first loss value which is a loss value pertaining to a shape that has been obtained by the shape estimating process.

### Supplementary Note B2

The information processing method described in Supplementary note B1, wherein:
in the estimating step, one or more distance function values are computed in the shape estimating process; and
the first loss value is a loss value pertaining to the one or more distance function values.

### Supplementary Note B3

The information processing method described in Supplementary note B1 or B2, wherein
the estimating step includes:
   a feature value converting step of converting the intermediate feature value in the completing process into a latent variable; and
   a shape estimating step of executing the shape estimating process with reference to the latent variable and the sampled three-dimensional structure data.

### Supplementary Note B4

The information processing method described in any one of Supplementary notes B1 to B3, wherein:
the completing step is executed by
   an encoder into which the sampled three-dimensional structure data is inputted and which outputs the intermediate feature value, and
   a decoder into which the intermediate feature value is inputted and which outputs completed three-dimensional structure data; and
in the first training step,
the encoder is subjected to machine learning with reference to the first loss value.

### Supplementary Note B5

The information processing method described in Supplementary note B4, including
a second training step of subjecting the encoder and the decoder to machine learning with reference to a second loss value that indicates a difference between the completed three-dimensional structure data which has been outputted by the decoder and the three-dimensional structure data which has been generated by the three-dimensional structure data generating step.

### Supplementary Note B6

The information processing method described in any one of Supplementary notes B1 to B5, wherein:
in the obtaining step, information pertaining to a position and orientation of an image capturing apparatus at a time when the image capturing apparatus captured an RGB image included in the input data is further obtained; and
the information processing method includes
a rendering step of executing a rendering process with reference to the shape which has been obtained by the shape estimating process and the information which pertains to the position and the orientation of the image capturing apparatus.

### Supplementary Note B7

The information processing method described in Supplementary note B6, further including
a third training step of executing a training process in which a third loss value is referred to, the third loss value indicating a difference between a rendered image which has been obtained by the rendering process and the RGB image which is included in the input data.

### Supplementary Note B8

An information processing method including:
an obtaining step of obtaining input data;
a three-dimensional structure data generating step of generating three-dimensional structure data from the input data;
a completing step of applying a completing process to the three-dimensional structure data; and
an output data generating step of generating output data from the three-dimensional structure data to which the completing process has been applied,
the completing step being a step which has been trained by:
   a sampling process of generating sampled three-dimensional structure data by sampling three-dimensional structure data generated from training data;
   a completing process which is executed in the completing step with respect to the sampled three-dimensional structure data;
   a shape estimating process in which an intermediate feature value in the completing process is referred to; and
   a first training process of training the completing step with reference to a first loss value which is a loss value pertaining to a shape that has been obtained by the shape estimating process.

### Supplementary Note B9

The information processing method described in Supplementary note B8, including
a displaying step of displaying the output data which has been generated by the output data generating step.

### Supplementary Note B10

The information processing method described in Supplementary note B9, wherein:
in the obtaining step, a medical image is obtained as the input data; and
in the displaying step, the output data for assisting a healthcare professional in making a decision is displayed.

### Supplementary Note B12

An information processing method including:
obtaining input data;
generating three-dimensional structure data from the input data;
applying, to the three-dimensional structure data, a completing process which is executed in a completing step; and
generating output data from the three-dimensional structure data to which the completing process has been applied,
the completing step being a step which has been trained by:
   generating sampled three-dimensional structure data by sampling three-dimensional structure data generated from training data;
   applying, to the sampled three-dimensional structure data, a completing process which is executed in the completing step;
   executing a shape estimating process in which an intermediate feature value in the completing process is referred to; and
   training the completing step with reference to a first loss value which is a loss value pertaining to a shape that has been obtained by the shape estimating process.

### Additional Remark C

The present disclosure includes techniques described in supplementary notes below. Note, however, that the present invention is not limited to the techniques described in the supplementary notes below, but may be altered in various ways by a skilled person within the scope of the claims.

### Supplementary Note C1

An information processing program for causing a computer to function as an information processing apparatus,
the information processing program causing the computer to function as:
   an obtaining means for obtaining input data;
   a three-dimensional structure data generating means for generating three-dimensional structure data from the input data;
   a sampling means for generating sampled three-dimensional structure data by sampling the three-dimensional structure data;
   a completing means for applying a completing process to the sampled three-dimensional structure data;
   an estimating means for executing a shape estimating process in which an intermediate feature value in the completing process is referred to; and
   a first training means for training the completing means with reference to a first loss value which is a loss value pertaining to a shape that has been obtained by the shape estimating process.

### Supplementary Note C2

The information processing program described in Supplementary note C1, wherein:
the estimating means computes one or more distance function values in the shape estimating process; and
the first loss value is a loss value pertaining to the one or more distance function values.

### Supplementary Note C3

The information processing program described in Supplementary note C1 or C2, wherein
the estimating means executes:
   a feature value converting process of converting the intermediate feature value in the completing process into a latent variable; and
   the shape estimating process in which the latent variable and the sampled three-dimensional structure data are referred to.

### Supplementary Note C4

The information processing program described in any one of Supplementary notes C1 to C3, wherein:
the completing means includes
   an encoder into which the sampled three-dimensional structure data is inputted and which outputs the intermediate feature value, and
   a decoder into which the intermediate feature value is inputted and which outputs completed three-dimensional structure data; and
the first training means subjects the encoder to machine learning with reference to the first loss value.

### Supplementary Note C5

The information processing program described in Supplementary note C4, wherein
the information processing program causes the computer to function as
a second training means for subjecting the encoder and the decoder to machine learning with reference to a second loss value that indicates a difference between the completed three-dimensional structure data which has been outputted by the decoder and the three-dimensional structure data which has been generated by the three-dimensional structure data generating means.

### Supplementary Note C6

The information processing program described in any one of Supplementary notes C1 to C5, wherein:
the obtaining means further obtains information pertaining to a position and orientation of an image capturing apparatus at a time when the image capturing apparatus captured an RGB image included in the input data; and
the information processing program causes the computer to further function as
a rendering means for executing a rendering process with reference to the shape which has been obtained by the shape estimating process and the information which pertains to the position and the orientation of the image capturing apparatus.

### Supplementary Note C7

The information processing program described in Supplementary note C6, wherein:
the information processing program causes the computer to further function as
a third training means for executing a training process in which a third loss value is referred to, the third loss value indicating a difference between a rendered image which has been obtained by the rendering process and the RGB image which is included in the input data.

### Supplementary Note C8

An information processing program for causing a computer to function as:
an obtaining means for obtaining input data;
a three-dimensional structure data generating means for generating three-dimensional structure data from the input data;
a completing means for applying a completing process to the three-dimensional structure data; and
an output data generating means for generating output data from the three-dimensional structure data to which the completing process has been applied,
the completing means being a means which has been trained by:
   a sampling process of generating sampled three-dimensional structure data by sampling three-dimensional structure data generated from training data;
   a completing process which is executed by the completing means with respect to the sampled three-dimensional structure data;
   a shape estimating process in which an intermediate feature value in the completing process is referred to; and
   a first training process of training the completing means with reference to a first loss value which is a loss value pertaining to a shape that has been obtained by the shape estimating process.

### Supplementary Note C9

The information processing program described in Supplementary note C8, wherein
the information processing program causes the computer to function as
a displaying means for displaying the output data which has been generated by the output data generating means.

### Supplementary Note C10

The information processing program described in Supplementary note C9, wherein:
the obtaining means obtains a medical image as the input data; and
the displaying means displays the output data for assisting a healthcare professional in making a decision.

### Supplementary Note C12

An information processing program for causing a computer to execute:
obtaining input data;
generating three-dimensional structure data from the input data;
applying, to the three-dimensional structure data, a completing process which is executed by a completing means; and
generating output data from the three-dimensional structure data to which the completing process has been applied,
the completing means being a means which has been trained by:
   generating sampled three-dimensional structure data by sampling three-dimensional structure data generated from training data;
   applying, to the sampled three-dimensional structure data, a completing process which is executed by the completing means;
   executing a shape estimating process in which an intermediate feature value in the completing process is referred to; and
   training the completing means with reference to a first loss value which is a loss value pertaining to a shape that has been obtained by the shape estimating process.

### Additional Remark D

The present disclosure includes techniques described in supplementary notes below. Note, however, that the present invention is not limited to the techniques described in the supplementary notes below, but may be altered in various ways by a skilled person within the scope of the claims.

### Supplementary Note D1

An information processing apparatus including
at least one processor,
the at least one processor executing:
an obtaining process of obtaining input data;
a three-dimensional structure data generating process of generating three-dimensional structure data from the input data;
a sampling process of generating sampled three-dimensional structure data by sampling the three-dimensional structure data;
a completing process of applying a completing process to the sampled three-dimensional structure data;
an estimating process of executing a shape estimating process in which an intermediate feature value in the completing process is referred to; and
a first training process of training the completing process with reference to a first loss value which is a loss value pertaining to a shape that has been obtained by the shape estimating process.

Note that the information processing apparatus may further include a memory. In the memory, a program for causing the at least one processor to execute each process may be stored.

### Supplementary Note D2

The information processing apparatus described in Supplementary note D1, wherein:
in the estimating process, the at least one processor computes one or more distance function value in the shape estimating process; and
the first loss value is a loss value pertaining to the one or more distance function values.

### Supplementary Note D3

The information processing apparatus described in Supplementary note D1 or D2, wherein
in the estimating process, the at least one processor executes:
   a feature value converting process of converting the intermediate feature value in the completing process into a latent variable; and
   a shape estimating process of executing the shape estimating process with reference to the latent variable and the sampled three-dimensional structure data.

### Supplementary Note D4

The information processing apparatus described in any one of Supplementary notes D1 to D3, wherein:
in the completing process, the at least one processor includes
   an encoder into which the sampled three-dimensional structure data is inputted and which outputs the intermediate feature value, and
   a decoder into which the intermediate feature value is inputted and which outputs completed three-dimensional structure data; and
in the first training process,
the encoder is subjected to machine learning with reference to the first loss value.

### Supplementary Note D5

The information processing apparatus described in Supplementary note D4, wherein
the at least one processor executes
a second training process of subjecting the encoder and the decoder to machine learning with reference to a second loss value that indicates a difference between the completed three-dimensional structure data which has been outputted by the decoder and the three-dimensional structure data which has been generated by the three-dimensional structure data generating process.

### Supplementary Note D6

The information processing apparatus described in any one of Supplementary notes D1 to D5, wherein:
in the obtaining process, the at least one processor further obtains information pertaining to a position and orientation of an image capturing apparatus at a time when the image capturing apparatus captured an RGB image included in the input data; and
the information processing apparatus executes
a rendering process of executing a rendering process with reference to the shape which has been obtained by the shape estimating process and the information which pertains to the position and the orientation of the image capturing apparatus.

### Supplementary Note D7

The information processing apparatus described in Supplementary note D6, wherein
the at least one processor further executes
a third training process of executing a training process in which a third loss value is referred to, the third loss value indicating a difference between a rendered image which has been obtained by the rendering process and the RGB image which is included in the input data.

### Supplementary Note D8

An information processing apparatus including
at least one processor,
the at least one processor executing:
an obtaining process of obtaining input data;
a three-dimensional structure data generating process of generating three-dimensional structure data from the input data;
a completing process of applying a completing process to the three-dimensional structure data; and
an output data generating process of generating output data from the three-dimensional structure data to which the completing process has been applied,
in the completing process, the at least one processor being a processor which has been trained by:
   a sampling process of generating sampled three-dimensional structure data by sampling three-dimensional structure data generated from training data;
   a completing process which is executed by the completing process with respect to the sampled three-dimensional structure data;
   a shape estimating process in which an intermediate feature value in the completing process is referred to; and
   a first training process of training the completing process with reference to a first loss value which is a loss value pertaining to a shape that has been obtained by the shape estimating process.

### Supplementary Note D9

The information processing apparatus described in Supplementary note D8, wherein
the at least one processor executes
a displaying process of displaying the output data which has been generated by the output data generating process.

### Supplementary Note D10

The information processing apparatus described in Supplementary note D9, wherein:
in the obtaining process, the at least one processor obtains a medical image as the input data; and
in the displaying process, the at least one processor displays the output data for assisting a healthcare professional in making a decision.

### Supplementary Note D12

An information processing apparatus including
at least one processor,
the at least one processor executing:
obtaining input data;
generating three-dimensional structure data from the input data;
applying, to the three-dimensional structure data, a completing process which is executed by a completing means; and
generating output data from the three-dimensional structure data to which the completing process has been applied,
in the completing process, the at least one processor being a processor which has been trained by:
   generating sampled three-dimensional structure data by sampling three-dimensional structure data generated from training data,
   applying, to the sampled three-dimensional structure data, a completing process which is executed by the completing means,
   executing a shape estimating process in which an intermediate feature value in the completing means is referred to; and
   training the completing means with reference to a first loss value which is a loss value pertaining to a shape that has been obtained by the shape estimating process.

### Additional Remark E

The present disclosure includes techniques described in supplementary notes below. Note, however, that the present invention is not limited to the techniques described in the supplementary notes below, but may be altered in various ways by a skilled person within the scope of the claims.

### Supplementary Note E1

A non-transitory recording medium in which an information processing program for causing a computer to function as an information processing apparatus is recorded,
the information processing program causing the computer to execute:
an obtaining process of obtaining input data;
a three-dimensional structure data generating process of generating three-dimensional structure data from the input data;
a sampling process of generating sampled three-dimensional structure data by sampling the three-dimensional structure data;
a completing process of applying a completing process to the sampled three-dimensional structure data;
an estimating process of executing a shape estimating process in which an intermediate feature value in the completing process is referred to; and
a first training process of training the completing process with reference to a first loss value which is a loss value pertaining to a shape that has been obtained by the shape estimating process.

### REFERENCE SIGNS LIST

1, 2, 100A, 100B, 100C Information processing apparatus
11, 21 Obtaining section (obtaining means)
12, 22 Three-dimensional structure data generating section (three-dimensional structure data generating means)
13, 23 Completing section (completing means)
14 Sampling section (sampling means)
15 Estimating section (estimating means)
16 First training section (first training means)
24 Output data generating section (output data generating means)

1. An information processing apparatus comprising
at least one processor and a memory which is configured to store instructions,
the at least one processor executing:
an obtaining process of obtaining input data;
a three-dimensional structure data generating process of generating three-dimensional structure data from the input data;
a sampling process of generating sampled three-dimensional structure data by sampling the three-dimensional structure data;
a completing process with respect to the sampled three-dimensional structure data with use of a completion model;
a shape estimating process in which an intermediate feature value in the completing process is referred to; and
a first training process of training the completion model with reference to a first loss value which is a loss value pertaining to a shape that has been obtained by the shape estimating process.

2. The information processing apparatus as set forth in claim 1, wherein:
in the shape estimating process, the at least one processor computes one or more distance function values; and
the first loss value is a loss value pertaining to the one or more distance function values.

3. The information processing apparatus as set forth in claim 2, wherein
the at least one processor
further executes a feature value converting process of converting the intermediate feature value in the completing process into a latent variable, and
executes the shape estimating process with reference to the latent variable and the sampled three-dimensional structure data.

4. The information processing apparatus as set forth in claim 1, wherein:
the completion model includes
an encoder into which the sampled three-dimensional structure data is inputted and which outputs the intermediate feature value, and
a decoder into which the intermediate feature value is inputted and which outputs completed three-dimensional structure data; and
in the first training process, the at least one processor subjects the encoder to machine learning with reference to the first loss value.

5. The information processing apparatus as set forth in claim 4, wherein
the at least one processor executes
a second training process of subjecting the encoder and the decoder to machine learning with reference to a second loss value that indicates a difference between the completed three-dimensional structure data which has been outputted by the decoder and the three-dimensional structure data which has been generated by the three-dimensional structure data generating process.

6. An information processing apparatus, comprising
at least one processor and a memory which is configured to store instructions,
the at least one processor executing:
an obtaining process of obtaining input data;
a three-dimensional structure data generating process of generating three-dimensional structure data from the input data;
a completing process with respect to the three-dimensional structure data with use of a completion model; and
an output data generating process of generating output data from the three-dimensional structure data to which the completing process has been applied,
the completion model being a model which has been trained by:
a sampling process of generating sampled three-dimensional structure data by sampling three-dimensional structure data generated from training data;
a completing process with respect to the sampled three-dimensional structure data with use of the completion model;
a shape estimating process in which an intermediate feature value in the completing process is referred to; and
a first training process of training the completion model with reference to a first loss value which is a loss value pertaining to a shape that has been obtained by the shape estimating process.

7. The information processing apparatus as set forth in claim 6, wherein
the at least one processor executes
a displaying process of displaying the output data which has been generated by the output data generating process.

8. The information processing apparatus as set forth in claim 7, wherein:
in the obtaining process, the at least one processor obtains a medical image as the input data; and
in the displaying process, the at least one processor displays the output data for assisting a healthcare professional in making a decision.

9. An information processing method comprising:
obtaining input data;
generating three-dimensional structure data from the input data;
generating sampled three-dimensional structure data by sampling the three-dimensional structure data;
applying, to the sampled three-dimensional structure data, a completing process with use of a completion model;
executing a shape estimating process in which an intermediate feature value in the completing process is referred to; and
training the completion model with reference to a first loss value which is a loss value pertaining to a shape that has been obtained by the shape estimating process.

10. A non-transitory recording medium in which a program for causing a computer to function as the information processing apparatus recited in claim 1 is stored, the program causing the computer to execute the obtaining process, the three-dimensional structure data generating process, the sampling process, the completing process, the estimating process, and the first training process.

11. A non-transitory recording medium in which a program for causing a computer to function as the information processing apparatus recited in claim 6 is stored, the program causing the computer to execute the obtaining process, the three-dimensional structure data generating process, the completing process, and the output data generating process.
